(19) United States
(12) Patent Application Publication
(10) Pub. No.: US 2024/0179089 A1
(43) Pub. Date: May 30, 2024

(54) CONTAINERIZED ROUTER SERVICE CHAINING FOR CONTAINERIZED NETWORK FUNCTIONS

(71) Applicant: Juniper Networks, Inc., Sunnyvale, CA (US)

(72) Inventors: Sasha Cirkovic, San Francisco, CA (US); Sachchidanand Vaidya, Santa Clara, CA (US); AnandaVelu Thulasiram, San Jose, CA (US); Aravind Srinivas Srinivasa Prabhakar, Arlington, MA (US); Sai Prashanth Ramanathan, Bangalore (IN); Yuvaraja Mariappan, San Jose, CA (US); Lavanya Kumar Ambatipudi, Fremont, CA (US); Vinay K Nallamothu, San Jose, CA (US)

(21) Appl. No.: 18/521,936

(22) Filed: Nov. 28, 2023

(30) Foreign Application Priority Data
Nov. 28, 2022 (IN) 202241068447

(51) Int. Cl. H04L 45/586; H04L 45/02; H04L 45/748

(52) U.S. Cl. CPC H04L 45/586; H04L 45/02; H04L 45/748

(57) ABSTRACT

The disclosure relates to computer networking and, more specifically, to service chaining a containerized network function (CNF) using a containerized router, the CNF and containerized router both deployed to the same server. In an example, a method comprises executing, with a computing device: a containerized network function; a virtual router to implement a data plane for a containerized router; and a containerized routing protocol daemon to implement a control plane for the containerized router, wherein the containerized network function and containerized routing protocol daemon execute on the same computing device, and wherein a first virtual network interface of the computing device enables communications between the containerized network function and the virtual router; and forwarding, by the virtual router, based on a static route, traffic destined for a prefix to the first virtual network interface to send the traffic to the containerized network function.

This application claims the benefit of India patent application 202241068447, filed 28 Nov. 2022, which is incorporated by reference herein in its entirety.

### TECHNICAL FIELD

The disclosure relates to computer networking and, more specifically, to service chaining containerized network functions.

### BACKGROUND

In a typical cloud data center environment, there is a large collection of interconnected servers that provide computing and/or storage capacity to run various applications. For example, a data center may comprise a facility that hosts applications and services for subscribers, i.e., customers of data center. The data center may, for example, host all of the infrastructure equipment, such as networking and storage systems, redundant power supplies, and environmental controls. In a typical data center, clusters of storage systems and application servers are interconnected via high-speed switch fabric provided by one or more tiers of physical network switches and routers. More sophisticated data centers provide infrastructure spread throughout the world with subscriber support equipment located in various physical hosting facilities.

Virtualized data centers are becoming a core foundation of the modern information technology (IT) infrastructure. In particular, modern data centers have extensively utilized virtualized environments in which virtual hosts, also referred to herein as virtual execution elements, such virtual machines or containers, are deployed and executed on an underlying compute platform of physical computing devices.

Virtualization within a data center or any environment that includes one or more servers can provide several advantages. One advantage is that virtualization can provide significant improvements to efficiency. As the underlying physical computing devices (i.e., servers) have become increasingly powerful with the advent of multicore microprocessor architectures with a large number of cores per physical CPU, virtualization becomes easier and more efficient. A second advantage is that virtualization provides significant control over the computing infrastructure. As physical computing resources become fungible resources, such as in a cloud-based computing environment, provisioning and management of the computing infrastructure becomes easier. Thus, enterprise IT staff often prefer virtualized compute clusters in data centers for their management advantages in addition to the efficiency and increased return on investment (ROI) that virtualization provides.

Containerization is a virtualization scheme based on operating system-level virtualization. Containers are light-weight and portable execution elements for applications that are isolated from one another and from the host. Because containers are not tightly-coupled to the host hardware computing environment, an application can be tied to a container image and executed as a single light-weight package on any host or virtual host that supports the underlying container architecture. As such, containers address the problem of how to make software work in different computing environments. Containers offer the promise of running consistently from one computing environment to another, virtual or physical.

With containers' inherently lightweight nature, a single host can often support many more container instances than traditional virtual machines (VMs). Often short-lived, containers can be created and moved more efficiently than VMs, and they can also be managed as groups of logically-related elements (sometimes referred to as “pods” for some orchestration platforms, e.g., Kubemetes). These container characteristics impact the requirements for container networking solutions: the network should be agile and scalable. VMs, containers, and bare metal servers may need to coexist in the same computing environment, with communication enabled among the diverse deployments of applications. The container network should also be agnostic to work with the multiple types of orchestration platforms that are used to deploy containerized applications.

A computing infrastructure that manages deployment and infrastructure for application execution may involve two main roles: (1) orchestration—for automating deployment, scaling, and operations of applications across clusters of hosts and providing computing infrastructure, which may include container-centric computing infrastructure; and (2) network management—for creating virtual networks in the network infrastructure to enable packetized communication among applications running on virtual execution environments, such as containers or VMs, as well as among applications running on legacy (e.g., physical) environments. Software-defined networking contributes to network management.

### SUMMARY

The disclosure relates to computer networking and, more specifically, to service chaining a containerized network function (CNF) using a containerized router, the CNF and containerized router both deployed to the same server. Using a pair of virtual network interfaces configured between the containerized router and the CNF, the containerized router can forward traffic for a particular destination according to whether the traffic is received on a virtual network interface with the CNF or is received on a different interface (e.g., a fabric or core-facing interface). For example, a different policy, virtual routing and forwarding instance (VRF), or other forwarding mechanism can be applied based on the interface with which the containerized router receives the traffic. Consequently, the CNF is paired with a full-fledged router on the same server, which provides the full suite of routing functionality for use in conjunction with the CNF. The combination of a full-fledged router and a CNF integrated on the same server enables new use cases for deployments to public clouds, on premises, and other platforms.

In some examples of the techniques of this disclosure, the CNF is deployed as an application container using a container network interface (CNI) developed for and capable of configuring the containerized router. Using this CNI permits automating the orchestration and configuration of the containerized router and the CNF, which may be packaged together and configured in part based on a service definition in a specification for the CNF. From the customer's perspective, both devices can be automated as a unified entity, which is a model that simplifies orchestration and configuration for the customer for any service/network function and use case. The service definition can specify, using additional attributes for the CNI, configuration data that includes routes for attracting traffic toward the CNF (from the containerized router) and causing the traffic processed by the CNF to be directed to the containerized router, which forwards the traffic on toward the destination. This effectively makes the containerized router a gateway for the traffic, with the CNF a service in a service chain managed by the containerized router.

The techniques may provide one or more technical advantages that realize one or more practical applications. In addition to the above described techniques advantages, the techniques enable orchestration and configuration of a software-based cloud native (containerized) network function in conjunction with a containerized router to enable new use cases for traffic processing (by the CNF) and forwarding (by the containerized router). As a cloud native solution, the techniques are agnostic/transparent with regard to the deployment platform. The CNF and containerized router can be deployed to any virtualized computing infrastructure that supports the orchestration platform, such as public, private, or hybrid clouds, on premises, and/or other infrastructures and platform services.

In an example, a computing device comprises processing circuitry having access to memory, the processing circuitry and memory configured to execute: a containerized network function; a virtual router to implement a data plane for a containerized router; and a containerized routing protocol daemon to implement a control plane for the containerized router, wherein the containerized network function and containerized routing protocol daemon execute on the same computing device; a first virtual network interface enabling communications between the containerized network function and the virtual router, wherein the virtual router is configured with a static route to cause the virtual router to forward traffic destined for a prefix to the first virtual network interface to send the traffic to the containerized network function

In an example, a computing system comprises an orchestrator; and a computing device configured with: a containerized network function; a virtual router to implement a data plane for a containerized router; and a containerized routing protocol daemon to implement a control plane for the containerized router, wherein the containerized network function and containerized routing protocol daemon execute on the same computing device; a first virtual network interface enabling communications between the containerized network function and the virtual router; a container network interface plugin, wherein the orchestrator is configured to: obtain a network attachment definition; and cause the container network interface plugin to configure the first virtual network interface based on the network attachment definition, wherein the virtual router is configured with a static route to cause the virtual router to forward traffic destined for a prefix to the first virtual network interface to send the traffic to the containerized network function.

In an example, a method comprises executing, with a computing device: a containerized network function: a virtual router to implement a data plane for a containerized router; and a containerized routing protocol daemon to implement a control plane for the containerized router, wherein the containerized network function and containerized routing protocol daemon execute on the same computing device, and wherein a first virtual network interface of the computing device enables communications between the containerized network function and the virtual router; and forwarding, by the virtual router, based on a static route, traffic destined for a prefix to the first virtual network interface to send the traffic to the containerized network function.

The details of one or more examples of this disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system in which examples of the techniques described herein may be implemented.

FIG. 2 is a block diagram of an example computing device (e.g., host), according to techniques described in this disclosure.

FIG. 3 illustrates an example topology for a network function and containerized router executing on a single server, in accordance with techniques of this disclosure.

FIG. 4 illustrates another example topology for a network function and containerized router executing on a single server, in accordance with techniques of this disclosure.

FIG. 5 illustrates another example topology for a network function and containerized router executing on a single server, in accordance with techniques of this disclosure.

FIG. 6 illustrates another example topology for a network function and containerized router, in accordance with techniques of this disclosure.

FIGS. 7-9 illustrate a containerized router in different use cases, in accordance with techniques of this disclosure.

FIG. 10 is a block diagram illustrating an example network system, in accordance with techniques of this disclosure.

FIG. 11 is a block diagram illustrating a network system in further detail, according to techniques of this disclosure.

FIG. 12 is a block diagram illustrating an example network system, in accordance with techniques of this disclosure.

FIG. 13 is a block diagram illustrating an example network system, in accordance with techniques of this disclosure.

FIG. 14 is a flowchart illustrating an example mode of operation for a computing device, according to techniques described in this disclosure.

Like reference characters denote like elements throughout the figures and text.

### DETAILED DESCRIPTION

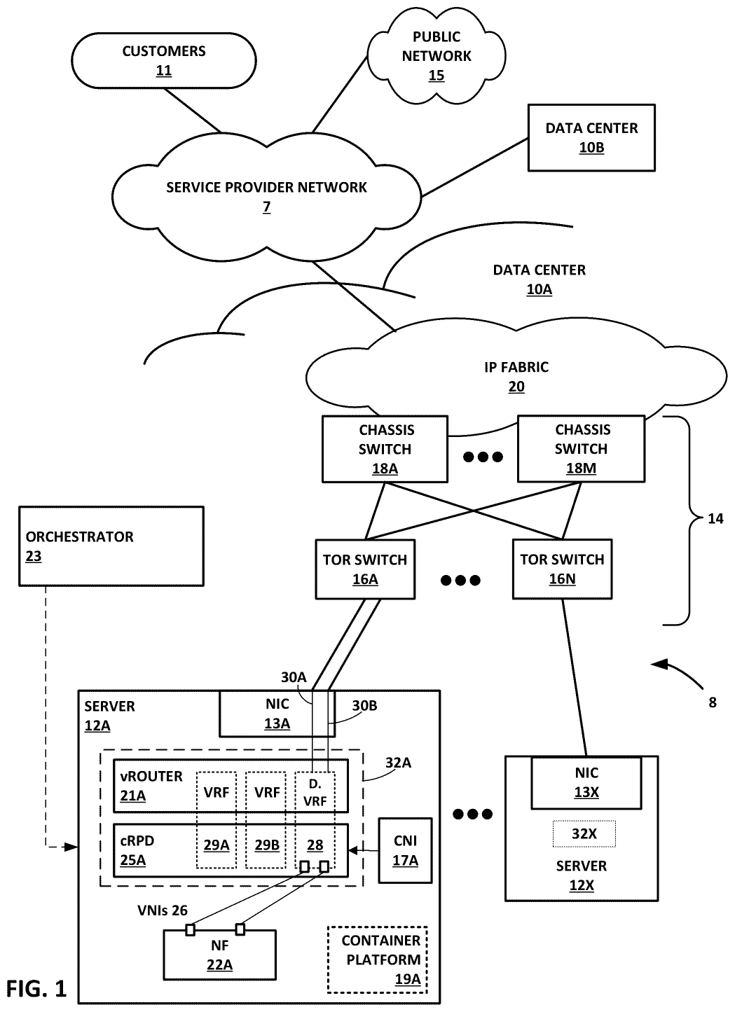

FIG. 1 is a block diagram illustrating an example system in which examples of the techniques described herein may be implemented. The system includes computing infrastructure 8, which may be a virtualized computing infrastructure. In general, data center 10 provides an operating environment for applications and services for customer sites 11 (illustrated as “customers 11”) having one or more customer networks coupled to a data center by service provider network 7. Each of data centers 10A-10B (collectively, “data centers 10”) may, for example, host infrastructure equipment, such as networking and storage systems, redundant power supplies, and environmental controls. The techniques are described further primarily with respect to data center 10A illustrated in greater detail.

Service provider network 7 is coupled to public network 15, which may represent one or more networks administered by other providers, and may thus form part of a large-scale public network infrastructure, e.g., the Internet. Public network 15 may represent, for instance, a local area network (LAN), a wide area network (WAN), the Internet, a virtual LAN (VLAN), an enterprise LAN, a layer 3 virtual private network (VPN), an Internet Protocol (IP) intranet operated by the service provider that operates service provider network 7, an enterprise IP network, or some combination thereof.

Although customer sites 11 and public network 15 are illustrated and described primarily as edge networks of service provider network 7, in some examples, one or more of customer sites 11 and public network 15 may be tenant networks within data center 10A or another data center. For example, data center 10A may host multiple tenants (customers) each associated with one or more virtual private networks (VPNs), each of which may implement one of customer sites 11.

Service provider network 7 offers packet-based connectivity to attached customer sites 11, data centers 10, and public network 15. Service provider network 7 may represent a network that is owned and operated by a service provider to interconnect a plurality of networks. Service provider network 7 may implement Multi-Protocol Label Switching (MPLS) forwarding and in such instances may be referred to as an MPLS network or MPLS backbone. In some instances, service provider network 7 represents a plurality of interconnected autonomous systems, such as the Internet, that offers services from one or more service providers. Service provider network 7 may be a layer 3 network and may represent or be part of a core network.

In some examples, data center 10A may represent one of many geographically distributed network data centers. As illustrated in the example of FIG. 1, data center 10A may be a facility that provides network services for customers. A customer of the service provider may be a collective entity such as enterprises and governments or individuals. For example, a network data center may host web services for several enterprises and end users. Other exemplary services may include network functions, data storage, virtual private networks, traffic engineering, file service, data mining, scientific- or super-computing, and so on. Although illustrated as a separate edge network of service provider network 7, elements of data center 10A, such as one or more physical network functions (PNFs) or virtualized network functions (VNFs), may be included within the service provider network 7 core.

In this example, data center 10A includes storage and/or compute servers (or “nodes”) interconnected via switch fabric 14 provided by one or more tiers of physical network switches and routers, with servers 12A-12X (collectively, “servers 12”) depicted as coupled to top-of-rack switches 16A-16N. Servers 12 are computing devices and may also be referred to herein as “hosts,” “host devices,” “host computing devices,” “compute nodes,” or other similar term. Although only server 12A coupled to TOR switch 16A is shown in detail in FIG. 1, data center 10A may include many additional servers coupled to other TOR switches 16 of the data center 10A, with such servers having hardware and software components similar to those illustrated with respect to server 12A.

Switch fabric 14 in the illustrated example includes interconnected top-of-rack (TOR) (or other “leaf”) switches 16A-16N (collectively, “TOR switches 16”) coupled to a distribution layer of chassis (or “spine” or “core”) switches 18A-18M (collectively, “chassis switches 18”). Although not shown, data center 10A may also include, for example, one or more non-edge switches, routers, hubs, gateways, security devices such as firewalls, intrusion detection, and/or intrusion prevention devices, servers, computer terminals, laptops, printers, databases, wireless mobile devices such as cellular phones or personal digital assistants, wireless access points, bridges, cable modems, application accelerators, or other network devices. Data center 10A may also include one or more physical network functions (PNFs) such as physical firewalls, load balancers, routers, route reflectors, broadband network gateways (BNGs), mobile core network elements, and other PNFs.

In this example, TOR switches 16 and chassis switches 18 provide servers 12 with redundant (multi-homed) connectivity to IP fabric 20 and service provider network 7. Chassis switches 18 aggregate traffic flows and provides connectivity between TOR switches 16. TOR switches 16 may be network devices that provide layer 2 (MAC) and/or layer 3 (e.g., IP) routing and/or switching functionality. TOR switches 16 and chassis switches 18 may each include one or more processors and a memory and can execute one or more software processes. Chassis switches 18 are coupled to IP fabric 20, which may perform layer 3 routing to route network traffic between data center 10A and customer sites 11 by service provider network 7. The switching architecture of data center 10A is merely an example. Other switching architectures may have more or fewer switching layers, for instance. IP fabric 20 may be or include one or more gateway routers.

The term “packet flow,” “traffic flow,” or simply “flow” refers to a set of packets originating from a particular source device or endpoint and sent to a particular destination device or endpoint. A single flow of packets may be identified by the 5-tuple: <source network address, destination network address, source port, destination port, protocol>, for example. This 5-tuple generally identifies a packet flow to which a received packet corresponds. An n-tuple refers to any n items drawn from the 5-tuple. For example, a 2-tuple for a packet may refer to the combination of <source network address, destination network address> or <source network address, source port> for the packet.

Servers 12 may each represent a compute server. For example, each of servers 12 may represent a computing device, such as an x86 processor-based server, configured to operate according to techniques described herein. Servers 12 may provide Network Function Virtualization Infrastructure (NFVI) for an NFV architecture that is an example of a virtualized computing infrastructure.

Any server of servers 12 may be configured with virtual execution elements by virtualizing resources of the server to provide an isolation among one or more processes (e.g., applications) executing on the server. “Hypervisor-based” or “hardware-level” or “platform” virtualization refers to the creation of virtual machines that each includes a guest operating system for executing one or more processes. In general, a virtual machine provides a virtualized/guest operating system for executing applications in an isolated virtual environment. Because a virtual machine is virtualized from physical hardware of the host server, executing applications are isolated from both the hardware of the host and other virtual machines. Each virtual execution element may be configured with one or more virtual network interfaces (VNIs) for communicating on corresponding virtual networks.

Virtual networks are logical constructs implemented on top of the physical networks. Virtual networks may be used to replace VLAN-based isolation and provide multi-tenancy in a virtualized data center, e.g., data center 10A. Each tenant or an application can have one or more virtual networks. Each virtual network may be isolated from all the other virtual networks unless explicitly allowed by security policy.

Virtual networks can be connected to and extended across physical Multi-Protocol Label Switching (MPLS) Layer 3 Virtual Private Networks (L3VPNs) and Ethernet Virtual Private Networks (EVPNs) using a datacenter 10 gateway router (not shown in FIG. 1). Virtual networks may also be used to implement Network Function Virtualization (NFV) and service chaining.

Virtual networks can be implemented using a variety of mechanisms. For example, each virtual network could be implemented as a Virtual Local Area Network (VLAN), Virtual Private Networks (VPN), etc. A virtual network can also be implemented using two networks—the physical underlay network made up of IP fabric 20 and switching fabric 14 and a virtual overlay network. The role of the physical underlay network is to provide an “IP fabric,” which provides unicast IP connectivity from any physical device (server, storage device, router, or switch) to any other physical device. The underlay network may provide uniform low-latency, non-blocking, high-bandwidth connectivity from any point in the network to any other point in the network.

As described further below with respect to virtual router 21A, virtual routers running in servers 12 may create a virtual overlay network on top of the physical underlay network using a mesh of dynamic “tunnels” amongst themselves. These overlay tunnels can be MPLS over GRE/UDP tunnels, or VXLAN tunnels, or NVGRE tunnels, for instance. The underlay physical routers and switches may not store any per-tenant state for virtual machines or other virtual execution elements, such as any Media Access Control (MAC) addresses, IP address, or policies. The forwarding tables of the underlay physical routers and switches may, for example, only contain the IP prefixes or MAC addresses of the physical servers 12. (Gateway routers or switches that connect a virtual network to a physical network are an exception and may contain tenant MAC or IP addresses.)

Virtual routers 21A-21X (collectively, “virtual routers 21”) of servers 12 often contain per-tenant state. For example, they may contain a separate forwarding table (a routing-instance) per virtual network. That forwarding table contains the IP prefixes (in the case of a layer 3 overlays) or the MAC addresses (in the case of layer 2 overlays) of the virtual machines or other virtual execution elements (e.g., pods of containers). No single virtual router 21 needs to contain all IP prefixes or all MAC addresses for all virtual machines in the entire data center. A given virtual router 21 only needs to contain those routing instances that are locally present on the server 12 (i.e., which have at least one virtual execution element present on the server 12 and requiring the routing instance).

“Container-based” or “operating system” virtualization refers to the virtualization of an operating system to run multiple isolated systems on a single machine (virtual or physical). Such isolated systems represent containers, such as those provided by the open-source DOCKER Container application or by CoreOS Rkt (“Rocket”). Like a virtual machine, each container is virtualized and may remain isolated from the host machine and other containers. However, unlike a virtual machine, each container may omit an individual operating system and instead provide an application suite and application-specific libraries. In general, a container is executed by the host machine as an isolated user-space instance and may share an operating system and common libraries with other containers executing on the host machine. Thus, containers may require less processing power, storage, and network resources than virtual machines. A group of one or more containers may be configured to share one or more virtual network interfaces for communicating on corresponding virtual networks.

In some examples, containers are managed by their host kernel to allow limitation and prioritization of resources (CPU, memory, block I/O, network, etc.) without the need for starting any virtual machines, in some cases using namespace isolation functionality that allows complete isolation of an application's (e.g., a given container) view of the operating environment, including process trees, networking, user identifiers and mounted file systems. In some examples, containers may be deployed according to Linux Containers (LXC), an operating-system-level virtualization method for running multiple isolated Linux systems (containers) on a control host using a single Linux kernel.

A Kubernetes Pod is a group of one or more logically-related containers with shared namespaces and shared filesystem volumes. Each Pod is assigned a unique IP address. Containers of a Pod share the network namespace, which includes the IP address and network ports. Containers of a Pod can communicate with one another using localhost. However, when containers in a Pod communicate with entities outside the Pod, the containers may share an IP address and port space. The containers in a Pod can also communicate with each other using standard inter-process communications. Containers in different Pods have different IP addresses. Containers that want to interact with a container running in a different Pod or external device can use IP networking to communicate, and this is typically set up using a Container Network Interface (CNI).

Servers 12 host virtual network endpoints for one or more virtual networks that operate over the physical network represented here by IP fabric 20 and switch fabric 14. Although described primarily with respect to a data center-based switching network, other physical networks, such as service provider network 7, may underlie the one or more virtual networks. In some cases, endpoints may be endpoints of the physical network.

Each of servers 12 may host one or more virtual execution elements each having at least one virtual network endpoint for one or more virtual networks configured in the physical network. A virtual network endpoint for a virtual network may represent one or more virtual execution elements that share a virtual network interface for the virtual network. For example, a virtual network endpoint may be a virtual machine, a set of one or more containers (e.g., a pod), or other virtual execution element(s), such as a layer 3 endpoint for a virtual network. The term “virtual execution element” encompasses virtual machines, containers, and other virtualized computing resources that provide an at least partially independent execution environment for applications. The term “virtual execution element” may also encompass a pod of one or more containers.

As shown in FIG. 1, server 12A hosts a software-based network device, network function 22A. Network function (NF) 22A may or may not be implemented as a virtual network endpoint. NF 22A may be a containerized network function (CNF). Example NFs can include security devices such as firewalls, intrusion detection and prevention devices, secure tunneling devices, as well as network address translation, gateway, or other network functions. Although server 12A is shown with only a single network function 22A, a server 12 may execute as many network functions as is practical given hardware resource limitations of the server 12.

Each of the virtual network endpoints may use one or more virtual network interfaces to perform packet I/O or otherwise process a packet. For example, a virtual network endpoint may use one virtual hardware component (e.g., an SR-IOV virtual function) enabled by NIC 13A to perform packet I/O and receive/send packets on one or more communication links with TOR switch 16A. Other examples of virtual network interfaces are described below.

Servers 12 include respective network interface cards (NICs) 13A-13X (collectively, “NICs 13”), which each includes at least one interface to exchange packets with TOR switches 16 over a communication link. For example, server 12A includes NIC 13A illustrated as having two links to TOR switch 16A. Any of NICs 13 may provide one or more virtual hardware components for virtualized input/output (I/O). A virtual hardware component for I/O may be a virtualization of the physical NIC (the “physical function”). For example, in Single Root I/O Virtualization (SR-IOV), which is described in the Peripheral Component Interface Special Interest Group SR-IOV specification, the PCIe Physical Function of the network interface card (or “network adapter”) is virtualized to present one or more virtual network interfaces as “virtual functions” for use by respective endpoints executing on the server 12. In this way, the virtual network endpoints may share the same PCIe physical hardware resources and the virtual functions are examples of virtual hardware components. As another example, one or more servers 12 may implement Virtio, a para-virtualization framework available, e.g., for the Linux Operating System, that provides emulated NIC functionality as a type of virtual hardware component to provide virtual network interfaces to virtual network endpoints. As another example, one or more servers 12 may implement Open vSwitch to perform distributed virtual multilayer switching between one or more virtual NICs (vNICs) for hosted virtual machines, where such vNICs may also represent a type of virtual hardware component that provide virtual network interfaces to virtual network endpoints. In some instances, the virtual hardware components are virtual I/O (e.g., NIC) components. In some instances, the virtual hardware components are SR-IOV virtual functions. In some examples, any server of servers 12 may implement a Linux bridge that emulates a hardware bridge and forwards packets among virtual network interfaces of the server or between a virtual network interface of the server and a physical network interface of the server. For Docker implementations of containers hosted by a server, a Linux bridge or other operating system bridge, executing on the server, that switches packets among containers may be referred to as a “Docker bridge.” The term “virtual router” as used herein may encompass a Contrail or Tungsten Fabric virtual router, Open vSwitch (OVS), an OVS bridge, a Linux bridge, Docker bridge, or other device and/or software that is located on a host device and performs switching, bridging, or routing packets among virtual network endpoints of one or more virtual networks, where the virtual network endpoints are hosted by one or more of servers 12. Virtual router 21A is an example of such a virtual router.

One or more of servers 12 may each include a corresponding virtual router 21 that executes one or more routing instances for corresponding virtual networks within data center 10A to provide virtual network interfaces and route packets among the virtual network endpoints. Each of the routing instances may be associated with a network forwarding table. Each of the routing instances may include a virtual routing and forwarding instance (VRF) for an Internet Protocol-Virtual Private Network (IP-VPN). Packets received by the virtual router 21A (illustrated as “vROUTER 21A”) of server 12A, for instance, on a fabric interface from the underlying physical network fabric of data center 10A (i.e., IP fabric 20 and switch fabric 14) may include an outer header to allow the physical network fabric to tunnel the payload or “inner packet” to a physical network address for a network interface card 13A of server 12A that executes the virtual router. The outer header may include not only the physical network address of the network interface card 13A of the server but also a virtual network identifier such as a VxLAN tag or MPLS label that identifies one of the virtual networks as well as the corresponding routing instance executed by the virtual router 21A. An inner packet includes an inner header having a destination network address that conforms to the virtual network addressing space for the virtual network identified by the virtual network identifier.

Virtual routers 21 terminate virtual network overlay tunnels and determine virtual networks for received packets based on tunnel encapsulation headers for the packets, and forwards packets to the appropriate destination virtual network endpoints for the packets. For server 12A, for example, for each of the packets outbound from virtual network endpoints hosted by server 12A, virtual router 21A attaches a tunnel encapsulation header indicating the virtual network for the packet to generate an encapsulated or “tunnel” packet, and virtual router 21A outputs the encapsulated packet via overlay tunnels for the virtual networks to a physical destination computing device, such as another one of servers 12. As used herein, virtual router 21 may execute the operations of a tunnel endpoint to encapsulate inner packets sourced by virtual network endpoints to generate tunnel packets and decapsulate tunnel packets to obtain inner packets for routing to other virtual network endpoints.

Virtual router 21 need not implement virtual networks in all examples. Virtual router 21 implements routing and forwarding functionality.

Each of virtual routers 21 may represent a SmartNIC-based virtual router, kernel-based virtual router (i.e., executed as a kernel module), or a Data Plane Development Kit (DPDK)-enabled virtual router in various examples. A DPDK-enabled virtual router 21A may use DPDK as a data plane. In this mode, virtual router 21A runs as a user space application that is linked to the DPDK library (not shown). This is a performance version of a virtual router and is commonly used by telecommunications companies, where the network functions are often DPDK-based applications. The performance of virtual router 21A as a DPDK virtual router can achieve higher throughput than a virtual router operating as a kernel-based virtual router. The physical interface is used by DPDK's poll mode drivers (PMDs) instead of Linux kernel's interrupt-based drivers.

A user-I/O (UIO) kernel module, such as vfio or uio_pci_generic, may be used to expose a physical network interface's registers into user space so that they are accessible by the DPDK PMD. When NIC 13A is bound to a UIO driver, it is moved from Linux kernel space to user space and therefore no longer managed nor visible by the Linux OS. Consequently, it is the DPDK application (i.e., virtual router 21A in this example) that fully manages NIC 13A. This includes packets polling, packets processing, and packets forwarding. User packet processing steps may be performed by the virtual router 21A DPDK data plane with limited or no participation by the kernel (kernel not shown in FIG. 1). The nature of this “polling mode” makes the virtual router 21A DPDK data plane packet processing/forwarding much more efficient as compared to the interrupt mode, particularly when the packet rate is high. There are limited or no interrupts and context switching during packet I/O.

Additional details of an example of a DPDK vRouter are found in “DAY ONE: CONTRAIL DPDK vROUTER,” 2021, Kiran K N et al., Juniper Networks, Inc., which is incorporated by reference herein in its entirety.

Servers 12 include and execute containerized routing protocol daemons 25A-25X (collectively, “cRPDs 25”). A containerized routing protocol daemon (cRPD) is a process that is packaged as a container and may run in Linux-based environments. cRPD may be executed in the user space of the host as a containerized process. Thus, cRPD makes available the rich routing software pedigree of physical routers on Linux-based compute nodes, e.g., servers 12 in some cases. cRPD provides control plane functionality. This control plane is thus containerized. For example, cRPD 25A implements the control plane for a containerized router 32A executed by server 12A.

Virtual routers 21, meanwhile, are the software entities that provide data plane functionality on servers 12. CRPD 25A may use the forwarding plane provided by the Linux kernel of server 12A for a kernel-based virtual router 21A. CRPD 25A may alternatively use a DPDK-enabled or SmartNIC-executed instance of virtual router 21A. Virtual router 21A may work with an SDN controller (e.g., network controller 24) to create the overlay network by exchanging routes, configurations, and other data. Virtual router 21A may be containerized. In combination, the containerized cRPD 25A and containerized virtual router 21A may thus be a fully functional containerized router 32A in some examples. However, as used herein, because cRPD 25A is containerized, containerized router 32A is considered as and referred to herein as containerized, regardless of the implementation of virtual router 21A.

Computing infrastructure 8 implements an automation platform for automating deployment, scaling, and operations of virtual execution elements across servers 12 to provide virtualized infrastructure for executing application workloads and services. In some examples, the platform may be a container orchestration platform that provides a container-centric infrastructure for automating deployment, scaling, and operations of containers to provide a container-centric infrastructure. “Orchestration,” in the context of a virtualized computing infrastructure generally refers to provisioning, scheduling, and managing virtual execution elements and/or applications and services executing on such virtual execution elements to the host servers available to the orchestration platform. Container orchestration, specifically, permits container coordination and refers to the deployment, management, scaling, and configuration, e.g., of containers to host servers by a container orchestration platform. Example instances of orchestration platforms include Kubernetes, Docker swarm, Mesos/Marathon, OpenShift, OpenStack, VMware, and Amazon ECS.

Orchestrator 23 represent one or more orchestration components for a container orchestration system. Orchestrator 23 orchestrates at least containerized RPDs 25. In some examples, the data plane virtual routers 21 are also containerized and orchestrated by orchestrator 23. The data plane may be a DPDK-based virtual router, for instance.

Elements of the automation platform of computing infrastructure 8 include at least servers 12 and orchestrator 23. Containers may be deployed to a virtualization environment using a cluster-based framework in which a cluster master node of a cluster manages the deployment and operation of containers to one or more cluster minion nodes of the cluster. The terms “master node” and “minion node” used herein encompass different orchestration platform terms for analogous devices that distinguish between primarily management elements of a cluster and primarily container hosting devices of a cluster. For example, the Kubernetes platform uses the terms “cluster master” and “minion nodes,” while the Docker Swarm platform refers to cluster managers and cluster nodes.

Orchestrator 23 may execute on any one or more servers 12 (a cluster) or on different servers. Orchestrator 23 may be a distributed application. Orchestrator 23 may implement master nodes for one or more clusters each having one or more minion nodes implemented by respective servers 12 (also referred to as “compute nodes”).

In general, orchestrator 23 controls the deployment, scaling, and operations of containers across clusters of servers 12 and providing computing infrastructure, which may include container-centric computing infrastructure. Orchestrator 23 respective cluster masters for one or more Kubernetes clusters. As an example, Kubernetes is a container management platform that provides portability across public and private clouds, each of which may provide virtualization infrastructure to the container management platform.

In one example, NF 22A is deployed as a Kubernetes pod. A pod is a group of one or more logically-related containers (not shown in FIG. 1), the shared storage for the containers, and options on how to run the containers. Where instantiated for execution, a pod may alternatively be referred to as a “pod replica.” Each container of a pod is an example of a virtual execution element. Containers of a pod are always co-located on a single server, co-scheduled, and run in a shared context. The shared context of a pod may be a set of Linux namespaces, cgroups, and other facets of isolation. Within the context of a pod, individual applications might have further sub-isolations applied. Typically, containers within a pod have a common IP address and port space and are able to detect one another via the localhost. Because they have a shared context, containers within a pod are also communicate with one another using inter-process communications (IPC). Examples of IPC include SystemV semaphores or POSIX shared memory. Generally, containers that are members of different pods have different IP addresses and are unable to communicate by IPC in the absence of a configuration for enabling this feature. Containers that are members of different pods instead usually communicate with each other via pod IP addresses.

Server 12A includes a container platform 19A for running containerized applications, such as NF 22A. Container platform 19A receives requests from orchestrator 23 to obtain and host, in server 12A, containers. Container platform 19A obtains and executes the containers.

Container network interface (CNI) 17A configures virtual network interfaces for virtual network endpoints and other containers (e.g., NF 22A) hosted on servers 12. The orchestrator 23 and container platform 19A use CNI 17A to manage networking for pods, such as NF 22A. For example, the CNI 17A creates virtual network interfaces (VNIs) to connect NF 22A to virtual router 21A and enable containers of such pods to communicate, via a pair of VNIs 26, to virtual router 21A. CNI 17A may, for example, insert the VNIs into the network namespace for NF 22A and configure (or request to configure) the other ends of VNIs 26 in virtual router 21A such that virtual router 21A is configured to send and receive packets via respective VNIs 26 with NF 22A. That is, virtual router 21A may send packets via one of the pair of VNIs 26 to NF 22A and receive packets from NF 22A via the other one of the pair of VNIs 26.

CNI 17A may assign network addresses (e.g., a virtual IP address for the virtual network) and may set up routes in containerized router 32A for VNIs 26. In Kubernetes, by default all pods can communicate with all other pods without using network address translation (NAT). In some cases, the orchestrator 23 create a service virtual network and a pod virtual network that are shared by all namespaces, from which service and pod network addresses are allocated, respectively. In some cases, all pods in all namespaces that are spawned in the Kubernetes cluster may be able to communicate with one another, and the network addresses for all of the pods may be allocated from a pod subnet that is specified by the orchestrator 23. When a user creates an isolated namespace for a pod, orchestrator 23 may create a new pod virtual network and new shared service virtual network for the new isolated namespace. Pods in the isolated namespace that are spawned in the Kubemetes cluster draw network addresses from the new pod virtual network, and corresponding services for such pods draw network addresses from the new service virtual network.

Kubemetes networking between pods is via plug-ins called Container Network Interfaces (CNIs) (also known as Container Network Interface plugins). However, the networking capabilities of typical CNIs are rather rudimentary and not suitable when the containerized network functions the CNI serves play a pivotal role within a network. A containerized router, as described herein, provides a better fit for these situations. A containerized router is a router with a containerized control plane that allows an x86 or ARM based host to be a first-class member of the network routing system, participating in protocols such as Intermediate System to Intermediate System (IS-IS) and Border Gateway Protocol (BGP) and providing Multiprotocol Label Switching/Segment Routing (MPLS/SR) based transport and multi-tenancy. In other words, rather than the platform being an appendage to the network (like a customer edge (CE) router), it may be operating as a provider edge (PE) router. Other documents refer to a containerized router instead as a “virtualized router.”

CNI plugin 17A (hereinafter, “CNI 17A”) may represent a library, a plugin, a module, a runtime, or other executable code for server 12A. CNI 17A may conform, at least in part, to the Container Network Interface (CNI) specification or the rkt Networking Proposal. CNI 17A may represent a Contrail, OpenContrail, Multus, Calico, cRPD, or other CNI. CNI 17A may alternatively be referred to as a network plugin or CNI plugin or CNI instance. CNI 17A may be developed for containerized router 32A and is capable of issuing configuration commands understood by containerized router 32A or of otherwise configuring containerized router 32A based on configuration data received from orchestrator 23.

CNI 17A is invoked by orchestrator 23. For purposes of the CNI specification, a container can be considered synonymous with a Linux network namespace. What unit this corresponds to depends on a particular container runtime implementation: for example, in implementations of the application container specification such as rkt, each pod runs in a unique network namespace. In Docker, however, network namespaces generally exist for each separate Docker container. For purposes of the CNI specification, a network refers to a group of entities that are uniquely addressable and that can communicate amongst each other. This could be either an individual container, a machine/server (real or virtual), or some other network device (e.g., a router). Containers can be conceptually added to or removed from one or more networks. The CNI specification specifies a number of considerations for a conforming plugin (“CNI plugin”).

Because cRPD 25A is a cloud-native application, it supports installation using Kubernetes manifests or Helm Charts. This includes the initial configuration of cRPD 25A as the control plane for containerized router 32A, including configuration of routing protocols and one or more virtual private networks. A cRPD may be orchestrated and configured, in a matter of seconds, with all of the routing protocol adjacencies with the rest of the network up and running. Ongoing configuration changes during the lifetime of cRPD 25A may be via a choice of CLI, Kubernetes manifests, NetConf or Terraform.

By adopting a Kubernetes CNI framework, containerized router 32A may mitigate the traditional operational overhead incurred when using a containerized appliance rather than its physical counterpart. By exposing the appropriate device interfaces, containerized router 32A may normalize the operational model of the virtual appliance to the physical appliance, eradicating the barrier to adoption within the operator's network operations environment. Containerized router 32A may present a familiar routing appliance look-and-feel to any trained operations team. Containerized router 32A has similar features and capabilities, and a similar operational model as a hardware-based platform. Likewise, a domain-controller can use the protocols that it is uses with any other router to communicate with and control containerized router 32A, for example Netconf/OpenConfig, gRPC, Path Computation Element Protocol (PCEP), or other interfaces. As described further herein, containerized router 32A is configurable according to cloud native principles by orchestrator 23 using CNI 17A.

Containerized router 32A may participate in IS-IS, Open Shortest Path First (OSPF), BGP, and/or other interior or exterior routing protocols and exchange routing protocol messages by peering with other routers, whether physical routers or containerized routers 32B-32X (collectively, “containerized routers 32”) residing on other hosts. In addition, MPLS may be used, often based on Segment Routing (SR). The reason for this is two-fold: to allow Traffic Engineering if needed, and to underpin multi-tenancy, by using VPNs, such as MPLS-based Layer 3 VPNs or EVPNs.

A virtual private network (VPN) offered by a service provider consists of two topological areas: the provider's network and the customer's network. The customer's network is commonly located at multiple physical sites and is also private (non-Internet). A customer site would typically consist of a group of routers or other networking equipment located at a single physical location. The provider's network, which runs across the public Internet infrastructure, consists of routers that provide VPN services to a customer's network as well as routers that provide other services. The provider's network connects the various customer sites in what appears to the customer and the provider to be a private network.

To ensure that VPNs remain private and isolated from other VPNs and from the public Internet, the provider's network maintains policies that keep routing information from different VPNs separate. A provider can service multiple VPNs as long as its policies keep routes from different VPNs separate. Similarly, a customer site can belong to multiple VPNs as long as it keeps routes from the different VPNs separate. In this disclosure, reference to a customer or customer network may not necessarily refer to an independent entity or business but may instead refer to a data center tenant, a set of workloads connected via a VPN across a layer 3 network, or some other logical grouping.

Although developed to run across service provider networks and the public Internet, VPN technology can be offered by any layer 3 network, and similar terminology is used. The provider network is often referred to instead as the layer 3 core network or simply the layer 3 network or core network. Layer 3 VPN operates at the Layer 3 level of the OSI model, the Network layer. A Layer 3 VPN is composed of a set of customer networks that are connected over the core network. A peer-to-peer model is used to connect to the customer sites, where the provider edge (PE) routers learn the customer routes on peering with customer edge (CE) devices. The common routing information is shared across the core network using multiprotocol BGP (MP-BGP), and the VPN traffic is forwarded among the PE routers using MPLS. Layer 3 VPNs may be based on Rosen & Rekhter, “BGP/MPLS IP Virtual Private Networks (VPNs),” Request for Comments 4364, Internet Engineering Task Force, Network Working Group, February 2006, which is incorporated by reference herein in its entirety.

Customer Edge (CE) devices connect to the provider network and may (or may not) offer reachability to other networks. PE devices are part of the layer 3 core network and connect to one or more CE devices to offer VPN services. In a PE router, the IP routing table (also called the global routing table or default routing table) contains service provider or underlay network routes not included in a virtual routing and forwarding (VRF) table. Provider edge devices need the IP routing table to be able to reach each other, while the VRF table is needed to reach all customer devices on a particular VPN. For example, a PE router with Interface A to a CE router and a core-facing Interface B places the Interface A addresses in the VRF and the Interface B addresses in the global IP routing table for the default VRF.

The virtual routing and forwarding (VRF) table distinguishes the routes for different VPNs, as well as VPN routes from provider/underlay routes on the PE device. These routes can include overlapping private network address spaces, customer-specific public routes, and provider routes on a PE device useful to the customer. A VRF instance consists of one or more routing tables, a derived forwarding table, the interfaces that use the forwarding table, and the policies and routing protocols that determine what goes into the forwarding table. Because each instance is configured for a particular VPN, each VPN has separate tables, rules, and policies that control its operation. A separate VRF table is created for each VPN that has a connection to a CE device. The VRF table is populated with routes received from directly connected CE devices associated with the VRF instance, and with routes received from other PE routers in the same VPN.

A Layer 3 VPN uses a peer routing model between PE router and CE devices that directly connect. That is, without needing multiple hops on the layer 3 core network to connect PE router and CE device pairs. The PE routers distribute routing information to all CE devices belonging to the same VPN, based on the BGP route distinguisher, locally and across the provider network. Each VPN has its own routing table for that VPN, coordinated with the routing tables in the CE and PE peers. A PE router can connect to more than one CE device, so the PE router has a general IP routing table and VRF table for each attached CE with a VPN.

In a Layer 2 VPN, traffic is forwarded to the router in L2 format. It is carried by MPLS over the layer 3 core network and then converted back to L2 format at the receiving site. You can configure different Layer 2 formats at the sending and receiving sites. On a Layer 2 VPN, routing is performed by the CE device, which must select the appropriate link on which to send traffic. The PE router receiving the traffic sends it across the layer 3 core network to the PE router connected to the receiving CE device. The PE routers do not need to store or process VPN routes. The PE routers only need to be configured to send data to the appropriate tunnel. The PE routers carry traffic between the CE devices using Layer 2 VPN interfaces. The VPN topology is determined by policies configured on the PE routers.

Ethernet VPN (EVPN) is a standards-based technology that provides virtual multipoint bridged connectivity between different Layer 2 domains over an IP or IP/MPLS backbone network. Like other VPN technologies, such as Layer 3 VPN and virtual private LAN service (VPLS), EVPN instances are configured on provider edge (PE) routers to maintain logical service separation between customers. The PE routers connect to CE devices, which can be routers, switches, or hosts. The PE routers then exchange reachability information using Multiprotocol BGP (MP-BGP), and encapsulated traffic is forwarded between PE routers. Elements of the EVPN architecture are common with other VPN technologies, such as Layer 3 VPNs, with the EVPN MAC-VRF being a type of VRF for storing MAC addresses on a PE router for an EVPN instance. An EVPN instance spans the PE devices participating in a particular EVPN and is thus similar conceptually to a Layer 3 VPN. Additional information about EVPNs if found in Sajassi et al., “BGP MPLS-Based Ethernet VPN,” Request for Comments 7432, Internet Engineering Task Force, February 2015, which is incorporated by reference herein in its entirety.

Containerized router 32A may operate as a provider edge (PE) router, i.e., a containerized PE router. Containerized router 32A may exchange VPN routes via BGP with other PE routers in the network, regardless of whether those other PEs are physical routers or virtualized routers 32 residing on other hosts. Each tenant may be placed in a separate VRF table on the containerized router 32A, giving the correct degree of isolation and security between tenants, just as with a conventional VPN service.

Containerized routers 32 may in this way bring the full spectrum of routing capabilities to computing infrastructure that hosts containerized applications. This may allow the platform to fully participate in the operator's network routing system and facilitate multi-tenancy. It may provide the same familiar look-and-free, operational experience and control-plane interfaces as a hardware-based router to provide virtual private networking to containerized applications.

In some cases, cRPD 25A may interface with two data planes, the kernel network stack for the compute node and the DPDK-based virtual router (where virtual router 21A is DPDK-based). CRPD 25A may leverage the kernel's networking stack to set up routing exclusively for the DPDK fast path. The routing information cRPD 25A receives can include underlay routing information and overlay routing information. CRPD 25A may run routing protocols on the vHost interfaces that are visible in the kernel, and cRPD 25A may install forwarding information base (FIB) updates corresponding to interior gateway protocol (IGP)-learned routes (underlay) in the kernel FIB (e.g., to enable establishment of multi-hop interior Border Gateway Protocol (iBGP) sessions to those destinations). Concurrently, virtual router 21A may notify cRPD 25a about the Application Pod interfaces created by CNI 17A for the compute node. CRPD 25A may advertise reachability to these Pod interfaces to the rest of the network as, e.g., L3VPN network layer reachability information (NLRI). Corresponding Multi-Protocol Label Switching (MPLS) routes may be programmed on the virtual router 21A, for the next-hop of these labels is a “POP and forward” operation to the Pod interface, and these interfaces are only visible in the virtual router. Similarly, reachability information received over BGP L3VPN may only be programmed to virtual router 21A, for Pods may need such reachability information for forwarding.

cRPD 25A includes default VRF 28 (illustrated as “D. VRF 28”) and VRFs 29A-29B (collectively, “VRFs 29”). Default VRF 28 stores the global routing table. cRPD 25A programs forwarding information derived from VRFs 29 into virtual router 21A. In this way, virtual router 21A implements the VPNs for VRFs 29 and implements the global routing table for default VRF 28, which are illustrated as included in both virtual router 21A and cRPD 25A. However, as noted before, containerized router 32A need not implement separate VRFs 29 for virtual networking or otherwise implement virtual networking.

cRPD 25A is configured to operate in host network mode, also referred to as native networking. cRPD 25A therefore uses the network namespace and IP address(es) of its host, i.e., server 12A. cRPD 25A has visibility and access to network interfaces 30A-30B of NIC 13A, which are inserted into default VRF 28 and considered by cRPD 25A as “core-facing interfaces” or as “fabric interfaces”. Interfaces 30A-30B are connected to switch fabric 14 and may be Ethernet interfaces. Interfaces 30 are considered and used as core-facing interfaces by cRPD 25A for providing traffic forwarding, and may be used for VPNs, for interfaces 30 may be used to transport VPN service traffic over a layer 3 network made up of one or more of switch fabric 14, IP fabric 20, service provider network 7, or public network 15.

In accordance with techniques of this disclosure, and as noted above, CNI 17A uses virtual network interface configuration data provided by orchestrator 23 to configure VNIs 26 for NF 22A, and to configure containerized router 32A to enable communications between NF 22A and virtual router 21A. This permits a service chaining model to be implemented by containerized router 32A and NF 22A, where containerized router 32A sends traffic to NF 22A for processing by the network function and receives traffic back from NF 22A after the traffic is processed.

Each of VNIs 26 is inserted into default VRF 28 of containerized router 32A. Each of VNIs 26 may represent virtual Ethernet (veth) pairs, where each end of the veth pair is a separate device (e.g., a Linux/Unix device) with one end of each veth pair inserted into a VRF of virtual router 21A and one end inserted into NF 22A. The veth pair or an end of a veth pair are sometimes referred to as “ports”. A virtual network interface may represent a macvlan network with media access control (MAC) addresses assigned to the containers/Pods and to virtual router 21A for communications between containers/Pods and virtual router 21A. In the case of a DPDK-enabled virtual router 21A, virtual network interfaces 26 may each represent a DPDK (e.g., vhost) interface, with one end of the DPDK interface inserted into a VRF and one end inserted into a pod. A container/Pod may operate as a vhost server in some examples, with virtual router 21A as the vhost client, for setting up a DPDK interface. Virtual router 21A may operate as a vhost server in some examples, with a container/Pod as the vhost client, for setting up a DPDK interface. Virtual network interfaces may alternatively be referred to as virtual machine interfaces (VMIs), pod interfaces, container network interfaces, tap interfaces, veth interfaces, virtual interfaces, or simply network interfaces (in specific contexts), for instance.

In some examples, the same service IP address or shared anycast IP address is given to multiple Pods for Equal-cost multipath (ECMP) or weighted ECMP. By advertising this shared IP address using BGP-add path into the network, the system can apply these load balancing technologies at layer 3. Existing Kubernetes load balancers provide L4-L7 application based load balancing. While typical layer load balancing uses NAT/firewall or a specialized module inside forwarding plane, the techniques can be used to achieve load balancing using the network routing itself.

cRPD 25A programs virtual router 21A with corresponding forwarding information derived from default VRF 28 and optionally the VRFs 29, and virtual router 21A forwards traffic according to the forwarding information.

cRPD 25A may apply many different types of overlay networks/VPNs, including L3VPN or EVPN (Type-2/Type-5), using a variety of underlay tunneling types, including MPLS, SR-MPLS, SRv6, MPLSoUDP, MPLSoGRE, or IP-in-IP, for example.

Any of the containers of a pod may utilize, i.e., share, any virtual network interface of the pod. Orchestrator 23 may store or otherwise manage virtual network interface configuration data for application deployments. Orchestrator 23 may receive specification for containerized applications (“pod specifications” in the context of Kubernetes) and network attachment definitions from a user, operator/administrator, or other machine system, for instance, and orchestrator 23 provides interface configuration data to CNI 17A to configure VNIs 26 to set up service chaining with NF 22A.

For example, as part of the process of creating pod 22A, orchestrator 23 may request that CNI 17A create a virtual network interface for default VRF 28 indicated in a pod specification and network attachment definition referred to by the pod specification. In accordance with techniques of this disclosure, the network attachment definition and pod specifications conform to a new model that allows the operator to specify routes that cRPD 25A is to advertise to attract traffic to NF 22A. Orchestrator 23 provides this information as topology configuration data to cRPD 25A via CNI 17A. cRPD 25A configures the topology configuration data as one or more routes in default VRF 28, which causes cRPD 25A to advertise the one or more routes to routing protocol peers. The network attachment definition for CNI refers to the configuration file or specification that defines how a network should be attached to a container, here a container/Pod for NF 22A.

Interface configuration data may include a container or pod unique identifier and a list or other data structure specifying, for each of the virtual network interfaces, network configuration data for configuring the virtual network interface. Network configuration data for a virtual network interface may include a network name, assigned virtual network address, MAC address, and/or domain name server values. An example of interface configuration data in JavaScript Object Notation (JSON) format is below.

CNI 17A creates each of the VNIs specified in the interface configuration data. For example, CNI 17A may attach one end of a veth pair implementing one of the VNI 26 pair to virtual router 21A and may attach the other end of the same veth pair to NF 22A, which may implement it using virtio-user.

The following is example interface configuration data for NF 22A for one of VNIs 26.

```
[{
  // virtual network interface 26
    ″id″: ″fe4bab62-a716-11e8-abd5-0cc47a698428″,
    ″instance-id″: ″fe3edca5-a716-11e8-822c-0cc47a698428″,
    ″ip-address″: ″10.47.255.250″,
    ″plen″: 12,
    ″vn-id″: ″56dda39c-5e99-4a28-855e-6ce378982888″,
    ″vm-project-id″: ″00000000-0000-0000-0000-000000000000″,
    ″mac-address″: ″02:fe:4b:ab:62:a7″,
    ″system-name″: ″tapeth0fe3edca″,
    ″rx-vlan-id″: 65535,
    ″tx-vlan-id″: 65535,
    ″vhostuser-mode″: 0,
    “v6-ip-address”: “::“,
    “v6-plen”: ,
    “v6-dns-server”: “::”,
    “v6-gateway”: “::”,
    ″dns-server″: ″10.47.255.253″,
    ″gateway″: ″10.47.255.254″,
}]
```

Using the pair of VNIs 26 configured between containerized router 32A and NF 22A, containerized router 32A can forward traffic for a particular destination according to whether the traffic is received on a VNI 26 with NF 22A or is received on a different interface, e.g., via one of interfaces 30. For example, a different policy, virtual routing and forwarding instance (VRF), route, or other forwarding mechanism can be applied based on the interface with which containerized router 32A receives the traffic. This is described in further detail elsewhere in this document. Consequently, NF 22A is paired with a full-fledged router (containerized router 32A) on the same server 12A, which provides the full suite of routing functionality for use in conjunction with NF 22A. The combination of a full-fledged router and a CNF integrated on the same server 12A enables new use cases for deployments to public clouds, on premises, and other platforms.

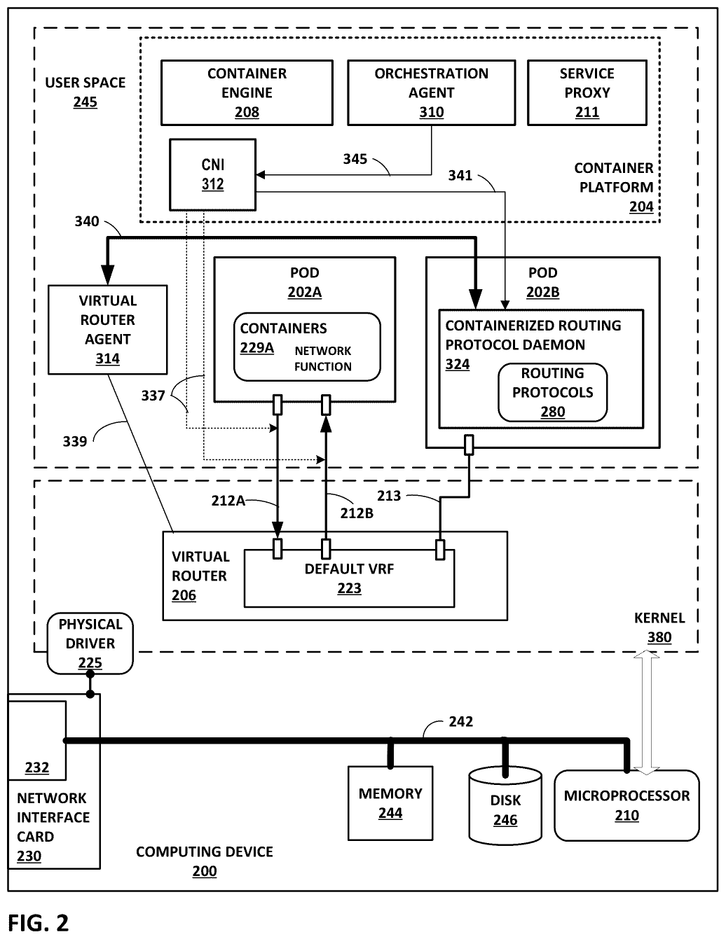

FIG. 2 is a block diagram of an example computing device (e.g., host), according to techniques described in this disclosure. Computing device 200 may represent a real or virtual server and may represent an example instance of any of servers 12 of FIG. 1. Computing device 200 includes in this example, a bus 242 coupling hardware components of a computing device 200 hardware environment. Bus 242 couples network interface card (NIC) 230, storage disk 246, and one or more microprocessors 210 (hereinafter, “microprocessor 210”). NIC 230 may be SR-IOV-capable. A front-side bus may in some cases couple microprocessor 210 and memory device 244. In some examples, bus 242 may couple memory device 244, microprocessor 210, and NIC 230. Bus 242 may represent a Peripheral Component Interface (PCI) express (PCIe) bus. In some examples, a direct memory access (DMA) controller may control DMA transfers among components coupled to bus 242. In some examples, components coupled to bus 242 control DMA transfers among components coupled to bus 242.

Microprocessor 210 may include one or more processors each including an independent execution unit to perform instructions that conform to an instruction set architecture, the instructions stored to storage media. Execution units may be implemented as separate integrated circuits (ICs) or may be combined within one or more multi-core processors (or “many-core” processors) that are each implemented using a single IC (i.e., a chip multiprocessor).

Disk 246 represents computer readable storage media that includes volatile and/or non-volatile, removable and/or non-removable media implemented in any method or technology for storage of information such as processor-readable instructions, data structures, program modules, or other data. Computer readable storage media includes, but is not limited to, random access memory (RAM), read-only memory (ROM), EEPROM, Flash memory, CD-ROM, digital versatile discs (DVD) or other optical storage, magnetic cassettes, magnetic tape, magnetic disk storage or other magnetic storage devices, or any other medium that can be used to store the desired information and that can be accessed by microprocessor 210.

Main memory 244 includes one or more computer-readable storage media, which may include random-access memory (RAM) such as various forms of dynamic RAM (DRAM), e.g., DDR2/DDR3 SDRAM, or static RAM (SRAM), flash memory, or any other form of fixed or removable storage medium that can be used to carry or store desired program code and program data in the form of instructions or data structures and that can be accessed by a computer. Main memory 244 provides a physical address space composed of addressable memory locations.

Network interface card (NIC) 230 includes one or more interfaces 232 configured to exchange packets using links of an underlying physical network. Interfaces 232 may include a port interface card having one or more network ports. NIC 230 may also include an on-card memory to, e.g., store packet data. Direct memory access transfers between the NIC 230 and other devices coupled to bus 242 may read/write from/to the NIC memory.

Memory 244, NIC 230, storage disk 246, and microprocessor 210 may provide an operating environment for a software stack that includes an operating system kernel 380 executing in kernel space. Kernel 380 may represent, for example, a Linux, Berkeley Software Distribution (BSD), another Unix-variant kernel, or a Windows server operating system kernel, available from Microsoft Corp. In some instances, the operating system may execute a hypervisor and one or more virtual machines managed by hypervisor. Example hypervisors include Kernel-based Virtual Machine (KVM) for the Linux kernel, Xen, ESXi available from VMware, Windows Hyper-V available from Microsoft, and other open-source and proprietary hypervisors. The term hypervisor can encompass a virtual machine manager (VMM). An operating system that includes kernel 380 provides an execution environment for one or more processes in user space 245.

Kernel 380 includes a physical driver 225 to use the network interface card 230. Network interface card 230 may also implement SR-IOV to enable sharing the physical network function (I/O) among one or more virtual execution elements, such as containers 229A or one or more virtual machines (not shown in FIG. 2). Shared virtual devices such as virtual functions may provide dedicated resources such that each of the virtual execution elements may access dedicated resources of NIC 230, which therefore appears to each of the virtual execution elements as a dedicated NIC. Virtual functions may represent lightweight PCIe functions that share physical resources with a physical function used by physical driver 225 and with other virtual functions. For an SR-IOV-capable NIC 230, NIC 230 may have thousands of available virtual functions according to the SR-IOV standard, but for I/O-intensive applications the number of configured virtual functions is typically much smaller.

Computing device 200 may be coupled to a physical network switch fabric that includes an overlay network that extends switch fabric from physical switches to software or “virtual” routers of physical servers coupled to the switch fabric, including virtual router 206. Virtual routers may be processes or threads, or a component thereof, executed by the physical servers, e.g., servers 12 of FIG. 1, that dynamically create and manage networks, optionally including one or more virtual networks, usable for communication between virtual network endpoints and external devices. In one example, virtual routers implement each virtual network using an overlay network, which provides the capability to decouple an endpoint's virtual address from a physical address (e.g., IP address) of the server on which the endpoint is executing. Each virtual network may use its own addressing and security scheme and may be viewed as orthogonal from the physical network and its addressing scheme. Various techniques may be used to transport packets within and across virtual networks over the physical network. The term “virtual router” as used herein may encompass an Open vSwitch (OVS), an OVS bridge, a Linux bridge, Docker bridge, or other device and/or software that is located on a host device and performs switching, bridging, or routing packets among virtual network endpoints of one or more virtual networks, where the virtual network endpoints are hosted by one or more of servers 12.

In the example computing device 200 of FIG. 2, virtual router 206 may be an example instance of virtual router 21A, cRPD 324 an examples instance of cRPD 25A, default VRF an example instance of default VRF 28, CNI 312 an example instance of CNI 17A, and so forth, of FIG. 1.

Virtual router 206 executes within kernel 380, but in some instances virtual router 206 may execute in user space as a DPDK-based virtual router, within a hypervisor, a host operating system, a host application, or a virtual machine. Virtual router 206 may replace and subsume the virtual routing/bridging functionality of the Linux bridge/OVS module that is commonly used for Kubernetes deployments of pods 202A-202B (collectively, “pods 202”). Pods 202 may or may not be virtual network endpoints. In FIG. 2, Pods 202 are not virtual network endpoints. Virtual router 206 may perform bridging (e.g., E-VPN) and routing (e.g., L3VPN, IP-VPNs) for virtual networks. Virtual router 206 may perform networking services such as applying security policies, NAT, multicast, mirroring, and load balancing.

Virtual router 206 can be executing as a kernel module or as a user space DPDK process (virtual router 206 is shown here in kernel 380) or in a SmartNIC. Virtual router agent 314 may also be executing in user space. Virtual router agent 314 has a connection to cRPD 324 using an interface 340, which is used to download configurations and forwarding information from cRPD 324. Virtual router agent 314 programs this forwarding state to the virtual router data (or “forwarding”) plane represented by virtual router 206. Virtual router 206 and virtual router agent 314 may be processes.

Virtual router agent 314 has a southbound interface 339 for programming virtual router 206. Reference herein to a “virtual router” may refer to the virtual router forwarding plane specifically, or to a combination of the virtual router forwarding plane (e.g., virtual router 206) and the corresponding virtual router agent (e.g., virtual router agent 314).

Virtual router 206 may be multi-threaded and execute on one or more processor cores. Virtual router 206 may include multiple queues. Virtual router 206 may implement a packet processing pipeline. The pipeline can be stitched by the virtual router agent 314 from the simplest to the most complicated manner depending on the operations to be applied to a packet. Virtual router 206 may maintain multiple instances of forwarding bases. Virtual router 206 may access and update tables using RCU (Read Copy Update) locks.

To send packets to other compute nodes or switches, virtual router 206 uses one or more physical interfaces 232. In general, virtual router 206 exchanges packets with workloads, such as VMs or pods 202 (in FIG. 2). Virtual router 206 may have multiple virtual network interfaces (e.g., vifs). These interfaces may include the kernel interface, vhost0, for exchanging packets with the host operating system; an interface with virtual router agent 314, pkt0, to obtain forwarding state from the network controller and to send up exception packets. There may be one or more virtual network interfaces corresponding to the one or more physical network interfaces 232.

Other virtual network interfaces of virtual router 206 are for exchanging packets with the workloads. Virtual network interfaces 212A-212B (collectively, “VNIs 212”) and 213 of virtual router 206 are illustrated in FIG. 2. Virtual network interfaces 212, 213 may be any of the aforementioned types of virtual interfaces. In some cases, virtual network interfaces 212, 213 are tap interfaces.

CRPD 324 is brought up to operate in host network mode. Virtual network interface 213 attached to default VRF 223 of virtual router 206 provides cRPD 324 with access to the host network interfaces of computing device. Pod 202B may therefore have a host IP address of computing device 200 on the underlay network.

Pod 202B may be assigned its own virtual layer three (L3) IP address for sending and receiving communications but may be unaware of an IP address of the computing device 200 on which the pod 202B executes. The virtual L3 (network) address may thus differ from the logical address for the underlying, physical computer system, e.g., computing device 200. The virtual network address may be specified in a pod specification or selected from a pool of addresses for a VPN.

Computing device 200 includes a virtual router agent 314 that controls the overlay of virtual networks for computing device 200, programs virtual router 206, and that coordinates the routing of data packets within computing device 200. In general, virtual router agent 314 communicates with cRPD 324, which generates commands to program forwarding information into virtual router 206. By configuring virtual router 206 based on information received from cRPD 324, virtual router agent 314 may support configuring network isolation, policy-based security, a gateway, source network address translation (SNAT), a load-balancer, and service chaining capability for orchestration.

In one example, network packets, e.g., layer three (L3) IP packets or layer two (L2) Ethernet packets generated or consumed by containers/Pods within the virtual network domain may be encapsulated in another packet (e.g., another IP or Ethernet packet) that is transported by the physical network. The packet transported in a virtual network may be referred to herein as an “inner packet” while the physical network packet may be referred to herein as an “outer packet” or a “tunnel packet.” Encapsulation and/or de-capsulation of virtual network packets within physical network packets may be performed by virtual router 206. This functionality is referred to herein as tunneling and may be used to create one or more overlay networks. Besides IPinIP, other example tunneling protocols that may be used include IP over Generic Route Encapsulation (GRE), VxLAN, Multiprotocol Label Switching (MPLS) over GRE, MPLS over User Datagram Protocol (UDP), etc. Virtual router 206 performs tunnel encapsulation/decapsulation for packets sourced by/destined to any containers of pods that are virtual network endpoints. Virtual router 206 forwards, according to default VRF 223 configuration, packets using interfaces 212, 213. Virtual router 206 exchanges packets with pods 202 via bus 242 and/or a bridge of NIC 230.

In general, a VRF stores forwarding information for the corresponding virtual network and identifies where data packets are to be forwarded and whether the packets are to be encapsulated in a tunneling protocol, such as with a tunnel header that may include one or more headers for different layers of the virtual network protocol stack. A VRF may include a network forwarding table storing routing and forwarding information for the virtual network.

NIC 230 may receive tunnel or other packets. Virtual router 206 processes a tunnel packet to determine, from the tunnel encapsulation header, the virtual network of the source and destination endpoints for the inner packet. Virtual router 206 may strip the layer 2 header and the tunnel encapsulation header to internally forward only the inner packet. The tunnel encapsulation header may include a virtual network identifier, such as a VxLAN tag or MPLS label, that indicates a virtual network, e.g., a virtual network corresponding to a VRF. The VRF may include forwarding information for the inner packet. For instance, the VRF may map a destination layer 3 address for the inner packet to a virtual network interface. The VRF forwards the inner packet via a virtual network interface to a Pod that is a virtual network endpoint.

Containers may also source inner packets as source virtual network endpoints. A container, for instance, may generate a layer 3 inner packet destined for a destination virtual network endpoint that is executed by another computing device (i.e., not computing device 200) or for another one of containers. The container may send the layer 3 inner packet to virtual router 206 via a virtual network interface attached to a VRF.

Virtual router 206 receives the inner packet and layer 2 header and determines a virtual network for the inner packet. Virtual router 206 may determine the virtual network using any of the above-described virtual network interface implementation techniques (e.g., macvlan, veth, etc.). Virtual router 206 uses the VRF corresponding to the virtual network for the inner packet to generate an outer header for the inner packet, the outer header including an outer IP header for the overlay tunnel and a tunnel encapsulation header identifying the virtual network. Virtual router 206 encapsulates the inner packet with the outer header. Virtual router 206 may encapsulate the tunnel packet with a new layer 2 header having a destination layer 2 address associated with a device external to the computing device 200, e.g., a TOR switch 16 or one of servers 12. If external to computing device 200, virtual router 206 outputs the tunnel packet with the new layer 2 header to NIC 230 using physical function 221. NIC 230 outputs the packet on an outbound interface. If the destination is another virtual network endpoint executing on computing device 200, virtual router 206 routes the packet to the appropriate virtual network interface.

Virtual network interfaces 212 are attached to default VRF 223, in which case VRF forwarding described above with respect to another VRF applies in similar fashion to default VRF 223 but without tunneling.

In some examples, a default route is configured in each of pods 202 to cause the Pods 202 to use virtual router 206 as an initial next hop for outbound packets. In some examples, NIC 230 is configured with one or more forwarding rules to cause all packets received from Pod 202 to be switched to virtual router 206.

Pod 202A includes one or more application containers 229A that implement a network function. Pod 202A may represent a containerized implementation of NF 22A of FIG. 1 that is deployed using a Pod. Pod 202B includes an instance of cRPD 324. Container platform 204 includes container runtime 208, orchestration agent 310, service proxy 211, and CNI 312.

Container engine 208 includes code executable by microprocessor 210. Container runtime 208 may be one or more computer processes. Container engine 208 runs containerized applications in the form of containers 229A. Container engine 208 may represent a Dockert, rkt, or other container engine for managing containers. In general, container engine 208 receives requests and manages objects such as images, containers, networks, and volumes. An image is a template with instructions for creating a container. A container is an executable instance of an image. Based on directives from orchestration agent 310, container engine 208 may obtain images and instantiate them as executable containers in pods 202A-202B.

Service proxy 211 includes code executable by microprocessor 210. Service proxy 211 may be one or more computer processes. Service proxy 211 monitors for the addition and removal of service and endpoints objects, and it maintains the network configuration of the computing device 200 to ensure communication among pods and containers, e.g., using services. Service proxy 211 may also manage iptables to capture traffic to a service's virtual IP address and port and redirect the traffic to the proxy port that proxies a backed pod. Service proxy 211 may represent a kube-proxy for a minion node of a Kubernetes cluster. In some examples, container platform 204 does not include a service proxy 211 or the service proxy 211 is disabled in favor of configuration of virtual router 206 and pods 202 by CNI 312.

Orchestration agent 310 includes code executable by microprocessor 210. Orchestration agent 310 may be one or more computer processes. Orchestration agent 310 may represent a kubelet for a minion node of a Kubernetes cluster. Orchestration agent 310 is an agent of an orchestrator, e.g., orchestrator 23 of FIG. 1, that receives container specification data for containers and ensures the containers execute by computing device 200. Container specification data may be in the form of a manifest file sent to orchestration agent 310 from orchestrator 23 or indirectly received via a command line interface, HTTP endpoint, or HTTP server. Container specification data may be a pod specification (e.g., a PodSpec—a YAML (Yet Another Markup Language) or JSON object that describes a pod) for one of pods 202 of containers 229. Based on the container specification data, orchestration agent 310 directs container engine 208 to obtain and instantiate the container images for containers 229, for execution of containers 229 by computing device 200.

In accordance with techniques of this disclosure, orchestration agent 310 instantiates or otherwise invokes CNI 312 with configuration 345 to configure VNIs 212 for pod 202A. For example, orchestration agent 310 receives a container specification data for pod 202A and directs container engine 208 to create the pod 202A with containers 229A based on the container specification data for pod 202A. Orchestration agent 310 also invokes the CNI 312 to configure, for pod 202A, virtual network interfaces 212.

CNI 312 obtains interface configuration data for configuring virtual network interfaces for pods 202. Virtual router agent 314 operates as a control plane module for enabling cRPD 324 to configure virtual router 206. Unlike the orchestration control plane (including the container platforms 204 for minion nodes and the master node(s), e.g., orchestrator 23), which manages the provisioning, scheduling, and managing virtual execution elements, the network control plane (including cRPD 324 and virtual router agent 314) manages the configuration of networks (including virtual networks) implemented in the data plane in part by virtual routers 206.

cRPD 324 executes one or more routing protocols 280, which may include an interior gateway protocol, such as OSPF, IS-IS, Routing Information Protocol (RIP), Interior BGP (IBGP), or another protocol. cRPD 324 advertises routing information using routing protocol messages of one of routing protocols 280. For example, such messages may be OSPF Link-State Advertisements, an RIP response message, a BGP UPDATE message, or other routing protocol message that advertises a route. Virtual router 206 may forward routing protocol messages received at VRF 223 to cRPD 324 for processing and import.

CNI 312 may program cRPD 324 via a management interface of cRPD 324. In some examples, orchestrator 23 pushes to CNI 312 (via orchestration agent 310) an initial configuration template as a ConfigMap. The ConfigMap may be a Kubernetes ConfigMap.

When Pod 202B including cRPD 324 is brought up, CNI 312 operates also as a controller to process the initial configuration template and generates configuration data 341 for cRPD 324. Configuration data 341 may conform to a management interface format, e.g., Netconf, CLI, or proprietary, and is sent to cRPD 324.

In some cases, cRPD 324 programs virtual router 206 with forwarding information computing using routing information, e.g., routing information learned via routing protocols 280.

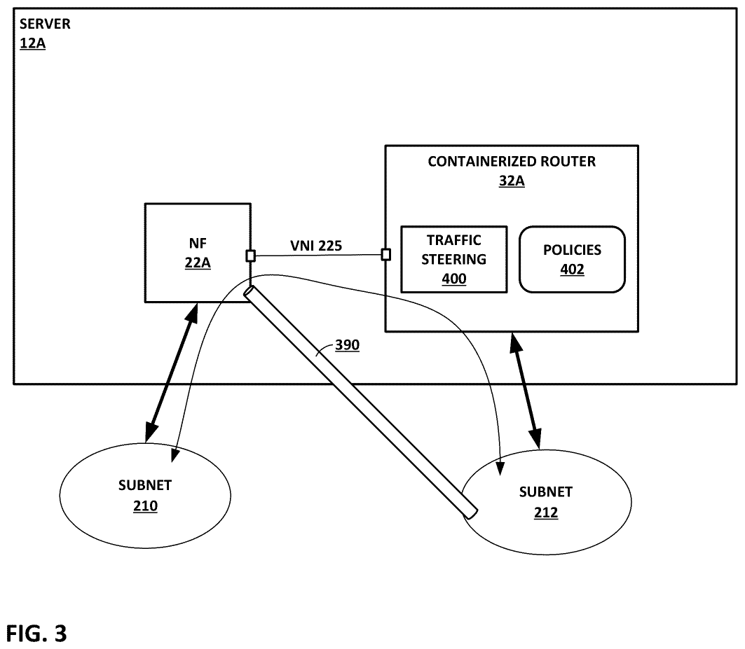

FIG. 3 illustrates an example topology for a network function 22A and containerized router 32A executing on a single server 12A, in accordance with techniques of this disclosure. Each of subnets 210, 212 may represent a physical and/or logical network, virtual private network, or the Internet, for example. Each of subnets 210, 212 may be associated with a cell site router, an enterprise network, a broadband network, a mobile core network such as an Evolved Packet Core or 5G Core Network, tenants thereof, or other devices or networks.

Network function 22A is attached to containerized router 32A with VNI 225, as described with respect to one or more aspects of this disclosure. Subnet 212 may be attached to a VRF of containerized router 32A. Subnet 210 is attached to NF 22A.

NF 22A may represent a virtualized security device, broadband network gateway, network address translation device, IPSec or other tunnel-specific device, an intrusion detection and prevention system, a firewall, Traffic Monitor, or other network function.

In this example, an endpoint for tunnel 390 is configured in NF 22A. Traffic received at server 12A from subnet 212 and associated with tunnel 390 may be encrypted and have a destination address that is in subnet 210. Tunnel 390 may represent an IPSec, GRE, IP-in-IP, or other type of tunnel.

Containerized router 32A applies traffic steering 400 according to configured policies 402. Policies 402 specify to send traffic received via tunnel 390 to NF 22A using VNI 225. Containerized router 32A is configured to send traffic received via tunnel 390 to NF 22A via VNI 225. NF 22A is configured to process the traffic and output the processed traffic to subnet 210. Traffic steering 400 may represent a traffic VRF.

In some examples, policies 402 are BGP import and/or export policies that cause containerized router 32A to import and/or export routes to implement traffic steering with an ingress VRF, egress VRF, one or more service VRFs, or other set of one or more VRFs, to cause containerized router 32A to send traffic received via tunnel 390 to NF 22A using VNI 225. Policies 402 may include routing policies and static routes.

Although illustrated as handling traffic associated with tunnel 390, the above-described techniques may apply to other types of traffic. In some examples, NF 22A is a network function only for select traffic identified in policies 402.

In this way, server 12A hosts both a routing function (containerized router 32A) and a service function (NF 22A) on a single server, and containerized router 32A can offload or outsource tunneling (e.g., IPSec) functionality to NF 22A. In some cases, containerized router 32A does not have tunneling (e.g., IPSec) functionality.

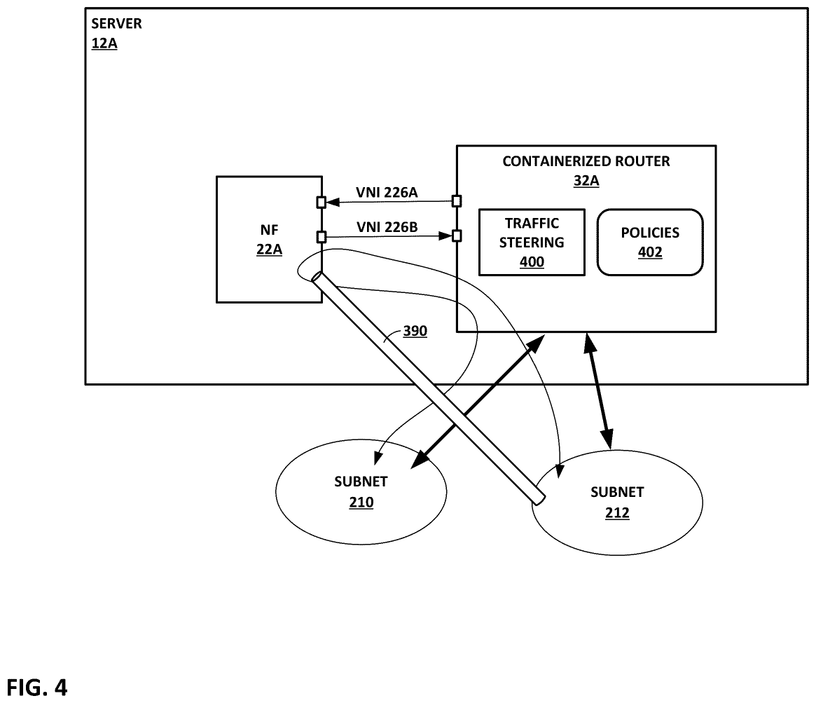

FIG. 4 illustrates another example topology for a network function 22A and containerized router 32A executing on a single server 12A, in accordance with techniques of this disclosure. In this example, both subnet 212 and subnet 213 are attached to one or more VRFs of containerized router 32A. A pair of virtual network interfaces 226A-226B (collectively, “VNIs 226”) enable communications between NF 22A and containerized router 32A.

In this example topology, containerized router 32A applies traffic steering 400 according to configured policies 402. Policies 402 specify to send traffic received via tunnel 390 to NF 22A using VNI 226. Containerized router 32A is configured to send encrypted traffic received via tunnel 390 to NF 22A via VNI 226A.

NF 22A is configured to decrypt the encrypted traffic and hairpin the decrypted traffic back to containerized router 32A via VNI 226B. Containerized router 32A is configured to output the traffic received from NF 22A differently, i.e., to output that traffic to subnet 210 via a different interface.

In the other direction, containerized router 32A receives traffic from subnet 210, applies policies 402 to forward the traffic via VNI 226A to NF 22A. NF 22A encrypts the traffic and sends the encrypted traffic via VNI 226A to containerized router 32A, which outputs the encrypted traffic via tunnel 390 to subnet 212.

Although illustrated as handling traffic associated with tunnel 390, the above-described techniques may apply to other types of traffic.

In some examples, policies 402 are BGP import and/or export policies that cause containerized router 32A to import and/or export routes to implement traffic steering with an ingress VRF, egress VRF, one or more service VRFs, or other set of one or more VRFs, to cause containerized router 32A to send traffic received via tunnel 390 to NF 22A using VNI 226A.

In some examples, policies 402 identify traffic from subnet 212 and traffic from NF 22A using different policies. NF 22A may process the traffic to keep the same destination address while modifying the source address, which allows containerized router 32A to distinguish traffic from subnet 212 and traffic from NF 22A. Policies 402 may be based on these differentiable traffic flows (source, destination) and therefore cause containerized router 32A to steer the traffic to the appropriate next hop, whether NF 22A or subnet 210.

In some examples, policies 402 identify traffic from subnet 212 and traffic from NF 22A using different policies that identify the interface on which the traffic was received. In such example, policies 402 can be used for policy-based routing based on virtual network interfaces.

In this way, server 12A hosts both a routing function (containerized router 32A) and a service function (NF 22A) on a single server, and containerized router 32A can offload or outsource tunneling (e.g., IPSec) functionality to NF 22A. In some cases, containerized router 32A does not have tunneling (e.g., IPSec) functionality.

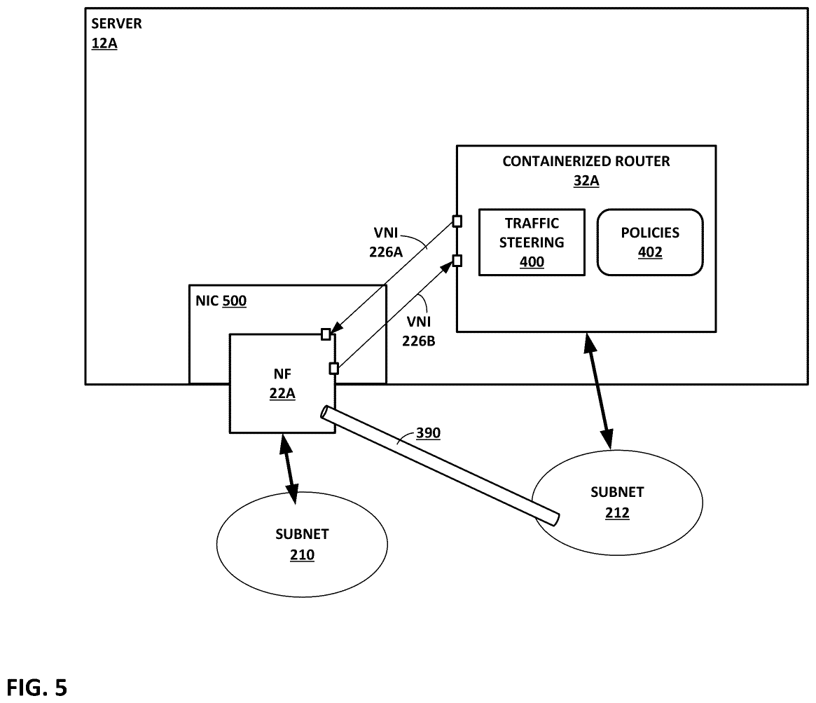

FIG. 5 illustrates another example topology for a network function 22A and containerized router 32A executing on a single server 12A, in accordance with techniques of this disclosure. In this example, network function 22A executes on a NIC 500 but the topology is otherwise similar to the topology illustrated and described with respect to FIG. 4. NIC 500 may be a SmartNIC.

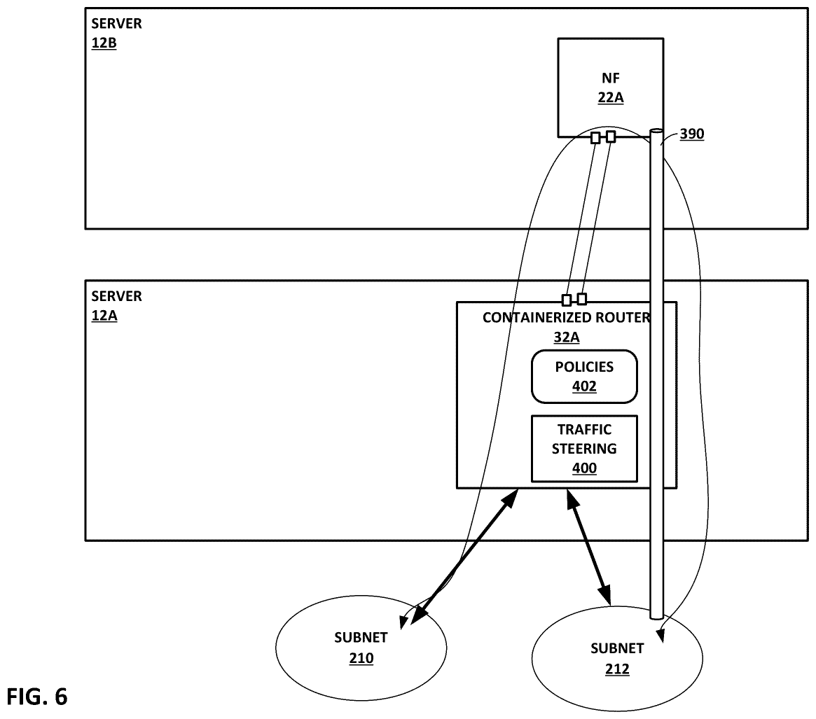

FIG. 6 illustrates another example topology for a network function 22A and containerized router 32A, in accordance with techniques of this disclosure. In this example, NF 22A is executed by a different server 12B.

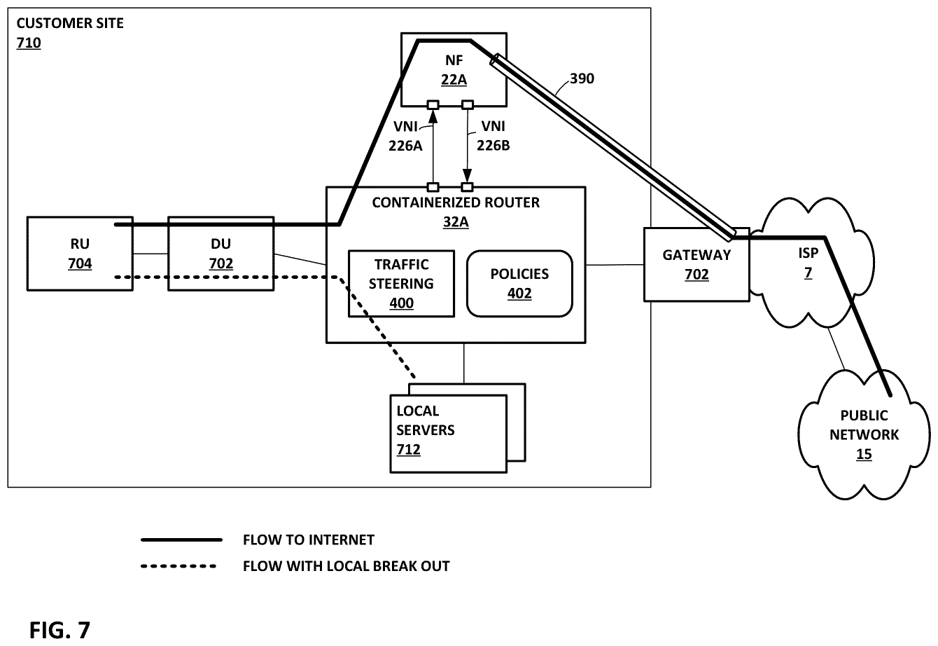

FIGS. 7-9 illustrate a containerized router in different use cases, in accordance with techniques of this disclosure. In some cases, the CNR supports cloud native network functions deployed to a public cloud provided by a cloud service provider.

In the example system of FIG. 7, NF 22A and containerized router 32A may be deployed using any of the example topologies of FIGS. 3-6 to support a cell site router, and IPSec tunnel may represent tunnel 390. Existing software-based or virtualized/containerized routers do not support IPSec. By service chaining with a NF 22A that supports IPSec, containerized router 32A and NF 22A can cooperatively receive a process IPSec traffic tunneled between an ISP network 7 (for instance, connecting customer site 710/gateway 702 to public network 15) and the cell site router implemented in part by containerized router 32A.

Cell Site Routers are described in further detail in U.S. Publication No. US 2022/0279420, published Sep. 1, 2022, which is incorporated by reference herein in its entirety. A cell site router may include one or more decentralized unit(s) 702 and one or more radio unit(s) 704 for a base station, according to the O-RAN implementation of the gNodeB for a 5G mobile network.

Containerized router 32A applying policies 402 can identify traffic local breakout to local servers 712 for processing.

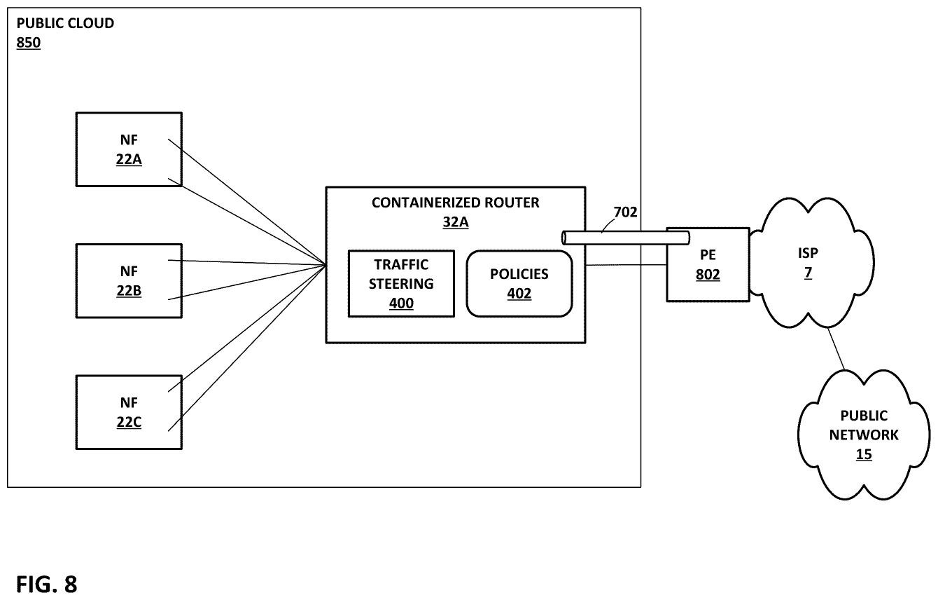

FIG. 8 illustrates a lightweight solution for rapid deployment. Containerized router 32A manages interfaces to load balance among multiple instances NF 22A-22C, e.g., using ECMP consistent hashing. Shown in FIG. 8 is an edge cloud use case in which traffic is redirected to the nearest edge site offering security services, and containerized router 32A advertises routes to attract, from PE 802 of ISP 7 across VxLAN 702, traffic for NFs 22A-22C.

NFs 22A-22C may be configured similarly to enable horizontal scaling. Where each of NFs 22A-22C are security devices, NFs 22A-22C may perform, for instance, URL filtering, Web filtering, intrusion detection and prevention (IDP/IPS), and/or IOT proxy, among other services. After applying the network function, NFs 22A-22C direct traffic back to containerized router 32A for forwarding toward the destination for the traffic.

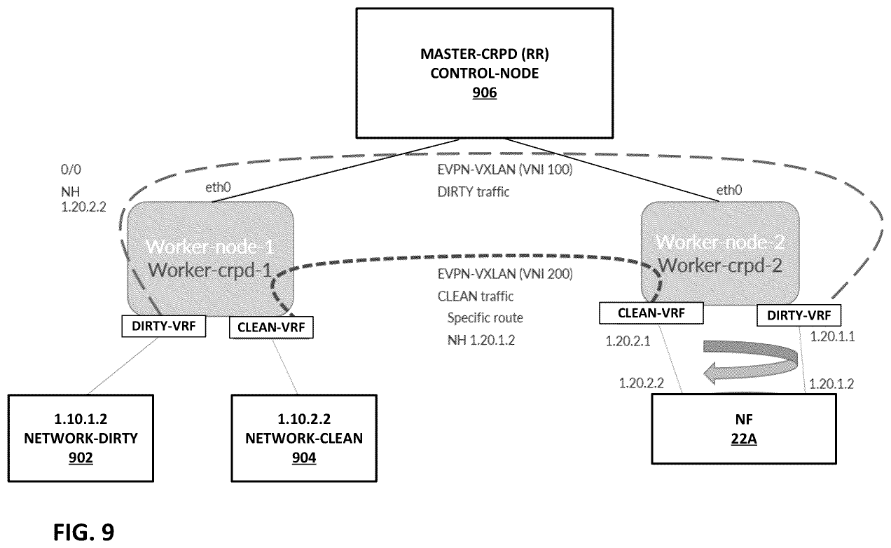

FIG. 9 illustrates a use case for next generation firewall (NGFW). The NF (“cSRX”) an be located on the same or on different worker nodes. The virtualized routers with “cRPD” control plane establish separate EVPN-VXLANs for clean and dirty traffic, which may be used for hair pinning as shown in the example topologies of FIG. 4 and FIG. 6.

FIG. 9 shows EVPN signaling with MPLS and VxLAN data plane for T5 routes. NF 22A can be on the same or a different server as the cRPD having interfaces to the dirty network 902 and clean network 904. In the illustrated example, NF 22A applies security services to “clean” traffic directed to it by a containerized router operating on Worker-node-2. A master-crpd control-node 906 operates as a route reflector and peers with the containerized routers of Worker-node-1 and Worker-node-2 to reflect routing protocol messages with which the containerized routers advertise routes. In particular, Worker-crpd-2 of the containerized router of Worker-node-2 advertises a route from its dirty-VRF to attract traffic that it can then forward to NF 22A.

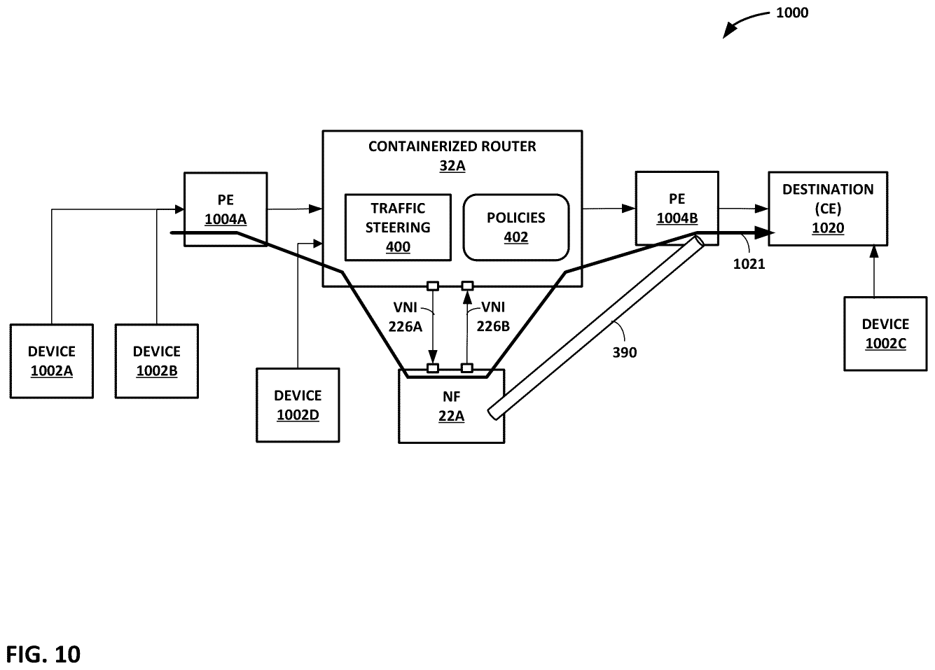

FIG. 10 is a block diagram illustrating an example network system, in accordance with techniques of this disclosure. System 1000 includes containerized router 32A that provides host-based service chaining of NF 22A using VNIs 226 to provide service integration of the network function of NF 22A. Containerized router 32A offers a rich routing plane and NF 22A integrates additional network functions. Host-based service chaining involves containerized router 32A and the service instance NF 22A running on a same compute cluster (e.g., a Kubernetes cluster). (Network-based service chaining is where a service instance is reachable over a network.) Containerized router 32A and NF 22A may execute on the same server.

Devices 1002A-1002D (collectively, “devices 1002”) represent computing devices and source and receive network traffic. Each of devices 1002 may be a member of a network. Provider edge routers (PEs) 1004A-1004B are provider edge routers of a layer 3 network, such as service provider network 7, another provider network, data center network, or other network. PEs 1004A-1004B may be provider edge routers of the same network or of different networks. Customer edge (CE) device 1020 offers connectivity to the layer 3 network to device 1002C.

In some cases, traffic from certain devices/CEs need to go through an IPSec tunnel. NF 22A may be a security device and provide IPSec tunneling functionality. Containerized router 32A acts as a node connecting PEs 1004 in a layer 3 network. Devices 1002A, 1002B are connected to PE 1004A; PE 1004A connects to containerized router 32A; and containerized router 32A connects to PE 1004B. Source devices/CEs (here, devices 1002A, 1002B) need to reach destination CE 1020 logically located behind the layer 3 network PE 1004B (refer to the illustration above). Traffic from devices 1002A, 1002B reaching containerized router 32A needs to be tunneled using IPSec. NF 22A and CE 1020 implement IPSec tunnel 390 initiated from NF 22A and terminating on CE 1020 behind PE 1004B. Containerized router 32A and its peering PE 1004A, 1004B provide underlay connectivity over which IPSec tunnel 390 operates. Traffic flow 1021 depicts the flow of traffic from source devices toward destination CE 1020 using IPSec tunnel 390. Containerized router 32A forwards unencrypted traffic to NF 22A via VNI 226A. NF 22A encrypts the traffic and sends the encrypted traffic to containerized router 32A via VNI 226B. Containerized router 32A forwards the encrypted traffic toward destination CE 1020, which terminates IPSec tunnel and forwards the decrypted traffic to ultimate destination device 1002C.

System 1000 offers a high level feature set provided by the integration of containerized router 32A and NF 22A, including one or more of: transit routing, IPv4, IPv6, L3 interfaces (no VLANs), BGP v4/v6, stateful firewall, site-to-site IPSec, local breakout/routing; and security services and containerized router 32A run on the same device.

In the use case depicted in FIG. 10, there may be only one IPSec tunnel per containerized router 32A instance. But future requirements may involve multi-tenancy on a single containerized router 32A instance. The illustrated use case supports one containerized router 32A chained with one NF 22A instance, which is orchestrated with a predefined configuration. Containerized router 32A is configured with static routes to steer traffic from containerized router 32A to NF 22A. NF 22A is configured with static routes to steer traffic to and from containerized router 32A. NF 22A supports only one IPSec tunnel. For multi-tenancy, multiple NF 22A instances can be orchestrated on the server together with containerized router 32A, containerized router 32A configured with appropriate static routes for each of the multiple NF 22A instances, and each of multiple NF 22A instances implementing a different IPSec tunnel for a different tenant.

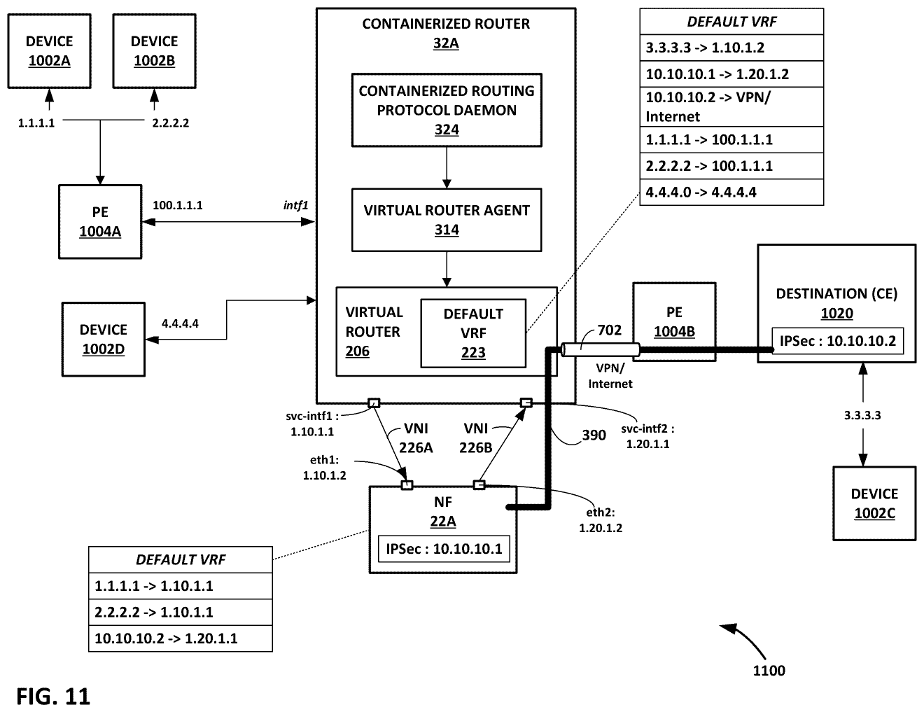

FIG. 11 is a block diagram illustrating a network system in further detail, according to techniques of this disclosure. System 1100 may represent an example configuration, in detail, for system 1000. Containerized router 32A includes cRPD 324, virtual router agent 314, and virtual router 206 to implement containerized router 32A, as described with respect to FIG. 2.

Containerized router 32A is configured with multiple interfaces. Device 1002A is connected to (or receives packets on) interface intf1 of containerized router 32A. NF 22A is connected to containerized router 32A with VNIs 226A-226B having two interfaces of containerized router 32A: svcs-intf1 and svcs-intf2. Forward traffic is referred to below as from device 1002A to device 1002C, and reverse traffic is the reverse.
svcs-intf1 is used to send
   forward traffic from containerized router 32A to NF 22A for IPSec encryption; containerized router 32A (virtual router 206) applies a static route that matches the traffic prefix, based on the traffic being received on a physical interface (or is otherwise not from NF 22A via svcs-intf2).
   reverse traffic from NF 22A to containerized router 32A after IPSec decryption
svcs-intf2 is used to send
   forward traffic from NF 22A to containerized router 32A after IPSec encryption;
   reverse traffic from containerized router 32A to NF 22A for IPSec decryption

The encryption path in the forward direction is as follows:
Containerized router 32A sends traffic received on intf/to NF 22A via svcs-intf/using a static route, which may be installed in default VRF 223.
NF 22A processes the traffic packets to IPSec encryption based on its configuration.
NF 22A sends encrypted packets to svcs-intf2.
Containerized router 32A receives the encrypted packets on svcs-intf2.
svcs-intf2 is part of inet.0 (default VRF 223). An encrypted packet goes through route lookup. Route lookup could result in an egress interface with relevant encapsulation.
Encapsulation can be MPLS (VPN tunnel 702) or plain internet traffic.

The decryption path in the reverse direction is as follows:
A packet received from internet/MPLS tunnel 702 gets decapsulated from the tunnel header, if present.
If the decapsulated packet is an IPSec packet, containerized router 32A sends the packet to NF 22A on svcs-intf2.
NF 22A receives the packet on svcs-intf2 and subjects the packet to decryption.
NF 22A sends the decrypted packet on svcs-intf1 to containerized router 32A.
Containerized router 32A receives the packet on svcs-intf1. Packet goes through a route lookup on default VRF 223.
Packet matches intf/route. Containerized router 32A sends the packet out of intf1.

Besides IPSec functions, this approach can also be used for NAT services and stateful firewall service, among other services. NF 22A may operate in routing mode where IPSec is supported in routing mode. This approach can be extended for other security offloads, such as SmartNICs and cryptography offloads.

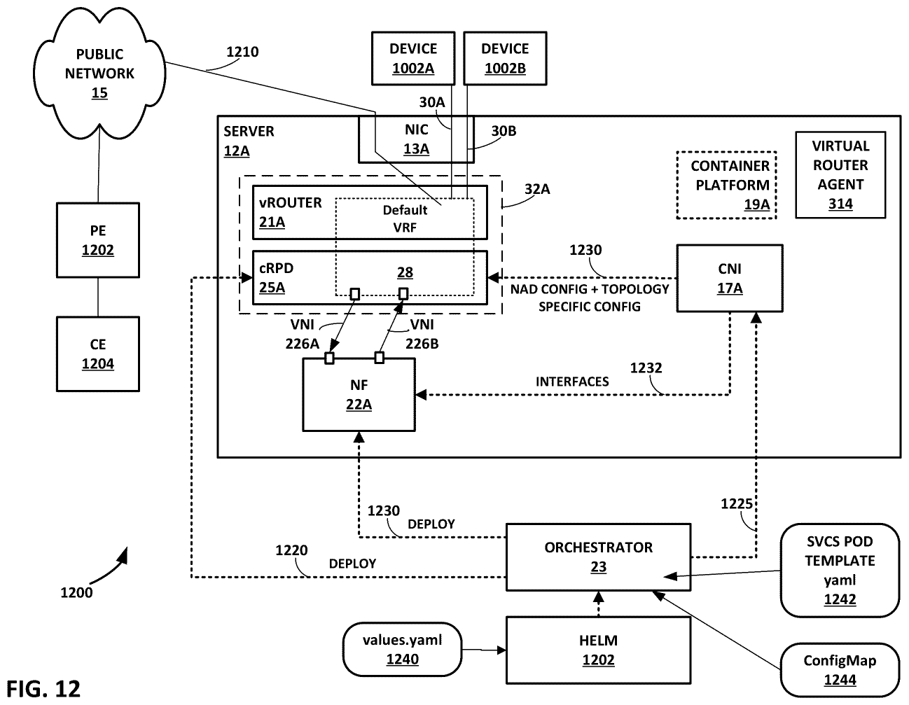

FIG. 12 is a block diagram illustrating an example network system, in accordance with techniques of this disclosure. System 1200 may represent, in parts, an example instance of system 100 of FIG. 1. For some examples, service chaining in host mode requires Pod services connecting to containerized router 32A. Containerized router 32A of system 1200 supports Pod services with NetworkAttachmentDefinition (NAD) configuration. This is extended to apply to service chain NF 22A with containerized router 32A. Containerized router 32A connects to NF 22A with two interfaces 226A, 226B and respective two NADs.

Containerized router 32A is to steer traffic to NF 22A. Because NF 22A (in system 1200) runs as a Pod service in L3 mode, system 1200 configures containerized router 32A with static routes to the Pod address. CNI 17A and virtual router agent 314 are extended to support configuring the static routes.

Orchestration with Static Configuration

Helm 1202 represents a package manager for orchestrator 23. Helm 1202 simplifies and streamlines the process of deploying and managing applications on compute clusters. Helm 1202 uses charts, which are packages of pre-configured resources, to define, install, and upgrade applications. A Helm chart is a package of pre-configured resources. It contains templates for manifest files, which can include deployments, services, ingress rules, and more. Charts allow a user to define, version, and package applications. Helm uses Templates to allow dynamic generation of manifest files based on user-provided values. Helm charts can include a values.yaml file 1240 where a user can specify configuration values for the chart. These values are used during the templating process to customize the manifests.

Orchestrator 23 deploys containerized router 32A (1220) via helm charts and deploys NF 22A as a Pod service via yaml file(s) 1242 (1230). The yaml file 1242 includes container specification data. Containerized router 32A and NF 22A may be deployed to together or separately. FIG. 12 depicts the orchestration model.

Initialization (“Day 0”) includes loading a containerized router 32A license using Kubernetes secrets, defining any configuration templates for the deployment, and containerized router 32A with an interface configuration and configuration template.

Deployment continues with the following steps:
Check if all components of containerized router 32A running.
Create 2 NADs with the following attributes:
   a. name
   b. type=jcnr
   c. vrfname
   d. vrftarget
Create a ConfigMap 1244 for NF 22A with at least two attributes:
   a. nf_config: captures all configuration that NF 22A needs to apply for given deployment.
   b. nf_license: license for NF 22A
Define Pod yaml file 1242 for NF 22A pointing to ConfigMap 1244 defined in previous step.
Deploy NF 22A pod using Pod yaml file 1242.
Ensure NF 22A Pod comes up with configuration and license defined in ConfigMap 1244
Configure containerized router 32A with:
   a. Routes to steer traffic from containerized router 32A to NF 22A to apply service. Static routes are programmed to point to NF 22A Pod address of VNI 226A as gateway, which containerized router 32A applies to traffic matching a prefix of the static route.
   b. For IPSec and similar tunneling use cases: routes to steer IPSec traffic coming from remote IPSec gateway to NF 22A. Static routes are programmed to point to NF 22A Pod address of VNI 226B as gateway.

### Updating Network Function

Updating containerized router 32A involves the Day 0 steps described above.

Updating NF 22A alone involves the following steps:
Bring down NF 22A Pod service.
Delete ConfigMap 1244.
Retain the 2 NAD definitions as is.
Pull new NF 22A image.
Proceed with remaining deployment steps beginning with creating a new ConfigMap 1244 for NF 22A.

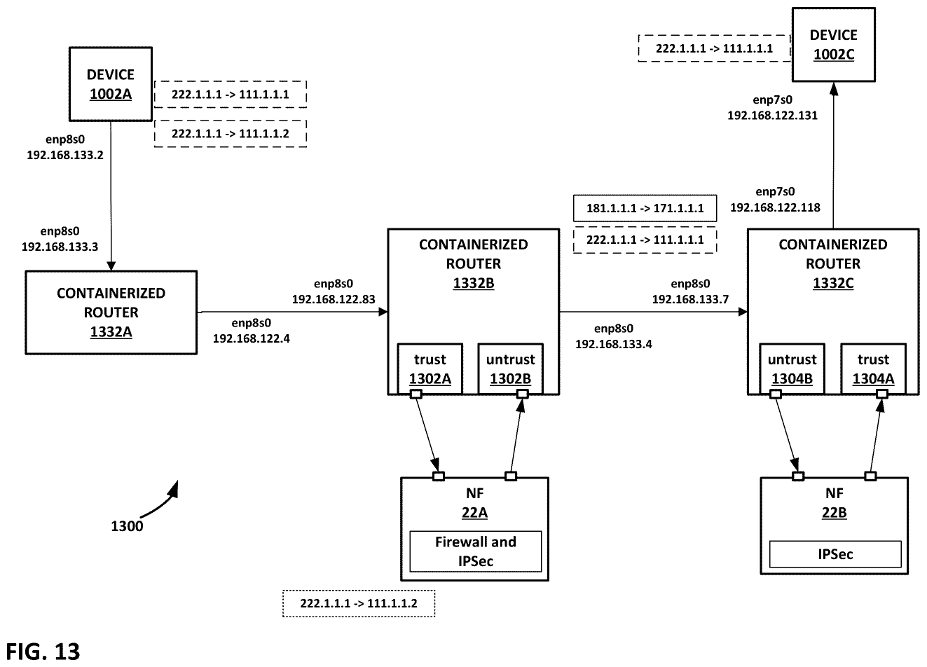

FIG. 13 is a block diagram illustrating an example network system, in accordance with techniques of this disclosure. System 1300 may represent, in parts, an example instance of system 100 of FIG. 1 and is configured in the illustrated topology. Containerized routers 1332A-1332C may represent example instances of containerized router 32A. In this topology, containerized routers 1132B-1332C provide service chaining for respective NFs 22A-22B implementing an IPSec tunnel. Containerized routers 1332B-1332C each trust and untrust VRFs. Containerized router 1332B has trust VRF 1302A and untrust VRF 1302B, and containerized router 1332C has trust VRF 1304A and untrust VRF 1304B. Untrust VRFs are so named because they have interfaces across an untrusted layer 3 network, thus necessitating the IPSec tunnel. Below are example configurations for containerized routers 1332B, 1332C, and NFs 22A-22B.

Containerized router 1332B—network attachment definition (NAD): Two network attachment definitions define trust VNR 1302A and untrust VRF 1302B for containerized router 1332B.

```
apiVersion: “k8s.cni.cncf.io/v1”
kind: NetworkAttachmentDefinition
metadata:
  name: net-untrust // untrust VRF 1302B
spec:
  config: ‘{
    “cniVersion”:“0.4.0”,
    “name”: “net-untrust”,
    “type”: “jcnr”,
    “args”: {
      “vrfName”: “untrust”,
      “vrfTarget”: “10:10”
    },
    “kubeConfig”:“/etc/kubernetes/kubelet.conf”
  }’
---
apiVersion: “k8s.cni.cncf.io/v1”
kind: NetworkAttachmentDefinition
metadata:
  name: net-trust // trust VRF 1302A
spec:
  config: ‘{
    “cniVersion”:“0.4.0”,
    “name”: “net-trust”,
    “type”: “jcnr”,
    “args”: {
      “vrfName”: “trust”,
      “vrfTarget”: “11:11”
    },
    “kubeConfig”:“/etc/kubernetes/kubelet.conf”
  }’
```

Pod config for NF 22A with containerized router 1332B. In accordance with techniques of this disclosure, the Pod specification for NF 22A extends cni-args with an advertiseRoutes key-value field. The advertiseRoutes field is topology configuration data. Orchestrator 23 sends the topology configuration data to a CNI 17 (not shown) for the server executing containerized router 1332B. Based on the topology configuration data 1230 including the advertiseRoutes value (here, a prefix), the CNI configures containerized router 1332B with (1) a static route to cause containerized router 1332B to direct traffic for the prefix to NF 22A via the VNI connecting trust VNF 1302A and NF 22A, and (2) a route in trust VRF that containerized router 1332B advertises to upstream peers (here, containerized router 1332A) to attract traffic for the prefix to containerized router 1332B. The prefixes in advertiseRoutes may be advertised using a BGP Update message with Network Layer Reachability Information indicating the prefix, and a next hop set to an IP address for containerized router 1332A. Including the advertiseRoutes value in cni-args integrates NF 22A and containerized router 1332B and allows the user to avoid having to separately configure containerized router 1332B. Instead, the CNI is extended to automatically handle NAD/interface and topology configurations for both containerized router 1332B and NF 22A, based on the topology information provided by the user in the NF 22A Pod specification (e.g., Pod template yaml 1242).

```
---
apiVersion: v1
kind: Pod
metadata:
  name: NF
  annotations:
    k8s.v1.cni.cncf.io/networks: |
      [
        {
          “name”: “net-trust”,
          “interface”:“eth1”,
          “cni-args”: {
            “advertiseRoutes”: [“111.1.1.0/24”],
            “mac”:“aa:bb.cc:dd:01:12”,
            “interfaceType”:“vhost”, ## veth/vhost
            “rd”: “11:11”,
            “dataplane”:“dpdk”,
            “ipConfig”:{
              “ipv4”:{
                “address”:“1.20.1.2/30”,
                “gateway”:“1.20.1.1”
              }
            }
          }
        },
        {
          “name”: “net-untrust”,
          “interface”:“eth2”,
          “cni-args”: {
            “mac”:“aa:bb:cc:dd:01:21”,
            “interfaceType”: “vhost”, ## veth/vhost
            “rd”: “10:10”,
            “dataplane”:“dpdk”,
            “ipConfig”:{
              “ipv4”:{
                “address”:“171.1.1.1/30”,
                “gateway”:“171.1.1.2”
              }
            }
          }
        }
      ]
spec:
  containers:
  - name: NF1
    securityContext:
        privileged: true
    image: NF:23.2-20231005.1705_RELEASE_232_THROTTLE
    imagePullPolicy: IfNotPresent
    env:
    - name: NF_SIZE
      value: “large”
    - name: NF_HUGEPAGES
      value: “yes”
    - name: NF_PACKET_DRIVER
      value: “poll”
    - name: NF_FORWARD_MODE
      value: “routing”
    - name: NF_AUTO_ASSIGN_IP
      value: “yes”
    - name: NF_MGMT_PORT_REORDER
      value: “no”
    - name: NF_TCP_CKSUM_CALC
      value: “yes”
    - name: NF_LICENSE_FILE
      value: “/var/jail/.NF_license”
    - name: NF_JUNOS_CONFIG
      value: “/var/jail/NF_config”
    - name: NF_CTRL_CPU
      value: “0x01”
    - name: NF_DATA_CPU
      value: “0x05”
    - name: KUBERNETES_POD_UID
      valueFrom:
        fieldRef:
          fieldPath: metadata.uid
    volumeMounts:
    - name: dpdk
      mountPath: /dpdk
      subPathExpr: $(KUBERNETES_POD_UID)
    - name: disk
      mountPath: “/dev”
    - name: config
      mountPath: “/var/jail”
    - mountPath: /mnt/huge
      name: hugepage
    resources:
      limits:
        hugepages-1Gi: 4Gi
        memory: 4Gi
      requests:
        hugepages-1Gi: 4Gi
        memory: 4Gi
  volumes:
  - name: dpdk
    hostPath:
      path: /var/run/jcnr/containers
  - name: disk
    hostPath:
      path: /dev
      type: Directory
  - name: hugepage
    hostPath:
      path: /mnt/huge
  - name: config
    configMap:
      name: NF-config-map
      items:
      - key: NF_config
        path: NF_config
      - key: NF_license
        path: .NF_license
ConfigMap for NF 22A
api Version: v1
kind: ConfigMap
metadata:
  name: NF-config-map
data:
    NF_license: | <>
    NF_config: | <>
```

The following are example configurations of containerized routers to effectuate the topology of system 1300 of FIG. 13.

### Containerized Router 1332A

set routing-options static route 111.1.1.0/24 next-hop 192.168.122.83
set routing-options static route 222.1.1.0/24 next-hop 192.168.133.2

### Containerized Router 1332B and NF 22A

set groups cni routing-instances trust instance-type vrf
set groups cni routing-instances trust routing-options static route 1.20.1.2/32 qualified-next-hop 1.20.1.2 interface jvketh1-37ae614
set groups cni routing-instances trust routing-options static route 111.1.1.0/24 qualified-next-hop 1.20.1.2 interface jvketh1-37ae614
set groups cni routing-instances trust interface jvketh1-37ae614
set groups cni routing-instances trust route-distinguisher 11:11
set groups cni routing-instances trust vrf-target target:11:11
set groups cni routing-instances untrust instance-type vrf
set groups cni routing-instances untrust routing-options static route 171.1.1.1/32 qualified-next-hop 171.1.1.1 interface jvketh2-37ae614
set groups cni routing-instances untrust interface jvketh2-37ae614
set groups cni routing-instances untrust route-distinguisher 10:10
set groups cni routing-instances untrust vrf-target target: 10:10
set apply-groups base
set apply-groups internal
set apply-groups cni
set routing-instances trust routing-options static route 222.1.1.0/24 next-hop 192.168.122.4
set routing-instances trust interface enp7s0
set routing-instances untrust routing-options static route 181.1.1.0/24 next-hop 192.168.133.7
set routing-instances untrust interface enp8s0

### Containerized Router 1332C and NF 22B

set groups cni routing-instances trust instance-type vrf
set groups cni routing-instances trust routing-options static route 181.1.1.1/32 qualified-next-hop 181.1.1.1 interface jvketh1-e7298f2
set groups cni routing-instances trust interface jvketh1-e7298f2
set groups cni routing-instances trust route-distinguisher 11:11
set groups cni routing-instances trust vrf-target target: 11:11
set groups cni routing-instances untrust instance-type vrf
set groups cni routing-instances untrust routing-options static route 1.21.1.2/32 qualified-next-hop 1.21.1.2 interface jvketh2-e7298f2
set groups cni routing-instances untrust routing-options static route 222.1.1.0/24 qualified-next-hop 1.21.1.2 interface jvketh2-e7298f2
set groups cni routing-instances untrust interface jvketh2-e7298f2
set groups cni routing-instances untrust route-distinguisher 10:10
set groups cni routing-instances untrust vrf-target target: 10:10
set apply-groups base
set apply-groups internal
set apply-groups cni
set routing-instances trust routing-options static route 171.1.1.0/24 next-hop 192.168.133.4
set routing-instances trust interface enp8s0
set routing-instances untrust routing-options static route 111.1.1.0/24 next-hop 192.168.122.131
set routing-instances untrust interface enp7s0

### NetworkAttachmentDefinition(s)

```
apiVersion: “k8s.cni.cncf.io/v1”
kind: NetworkAttachmentDefinition
metadata:
  name: net-untrust
spec:
  config: ‘{
    “cniVersion”:“0.4.0”,
    “name”: “net-untrust”,
    “type”: “jcnr”,
    “args”: {
      “vrfName”: “untrust”
      “vrfTarget”: “10:10”
    },
    “kubeConfig”:“/etc/kubernetes/kubelet.conf”
  }’
---
apiVersion: “k8s.cni.cncf.io/v1”
kind: NetworkAttachmentDefinition
metadata:
  name: net-trust
spec:
  config: ‘{
    “cniVersion”:“0.4.0”,
    “name”: “net-trust”,
    “type”: “jcnr”,
    “args”: {
      “vrfName”: “trust”,
      “vrfTarget”: “11:11”
    },
    “kubeConfig”:“/etc/kubernetes/kubelet.conf”
  }’
POD config for NF 22B
---
apiVersion: v1
kind: Pod
metadata:
  name: NF
  annotations:
    k8s.v1.cni.cncf.io/networks: |
      [
        {
          “name”: “net-trust”,
          “interface”:“eth1”,
          “cni-args”: {
            “mac”:“aa:bb:cc:dd:01:12”,
            “interfaceType”:“veth”,
            “rd”: “11:11”,
            “dataplane”:“dpdk”,
            “ipConfig”:{
              “ipv4”:{
                “address”:“181.1.1.1/30”,
                “gateway”:“181.1.1.2”
              }
            }
          }
        },
        {
          “name”: “net-untrust”,
          “interface”:“eth2”,
          “cni-args”: {
            “advertiseRoutes”: [“222.1.1.0/24”],
            “mac”:“aa:bb:cc:dd:01:21”,
            “interfaceType”: “veth”,
            “rd”: “10:10”,
            “dataplane”:“dpdk”,
            “ipConfig”: {
              “ipv4”:{
                “address”:“1.21.1.2/30”,
                “gateway”:“1.21.1.1”
              }
            }
          }
        }
      ]
POD config for NF 22A
---
apiVersion: v1
kind: Pod
metadata:
  name: NF
  annotations:
    k8s.v1.cni.cncf.io/networks: |
      [
        {
          “name”: “net-trust”,
          “interface”:“eth1”,
          “cni-args”: {
            “advertiseRoutes”: [“111.1.1.0/24”],
            “mac”:“aa:bb:cc:dd:01:12”,
            “interfaceType”:“veth”,
            “rd”: “11:11”,
            “dataplane”:“dpdk”,
            “ipConfig”:{
              “ipv4”:{
                “address”:“1.20.1.2/30”,
                “gateway”:“1.20.1.1”
              }
            }
          }
        },
        {
          “name”: “net-untrust”,
          “interface”:“eth2”,
          “cni-args”: {
            “mac”:“aa:bb:cc:dd:01:21”,
            “interfaceType”: “veth”,
            “rd”: “10:10”,
            “dataplane”:“dpdk”,
            “ipConfig”:{
              “ipv4”:{
                “address”:“171.1.1.1/30”,
                “gateway”:“171.1.1.2”
              }
            }
          }
        }
      ]
```

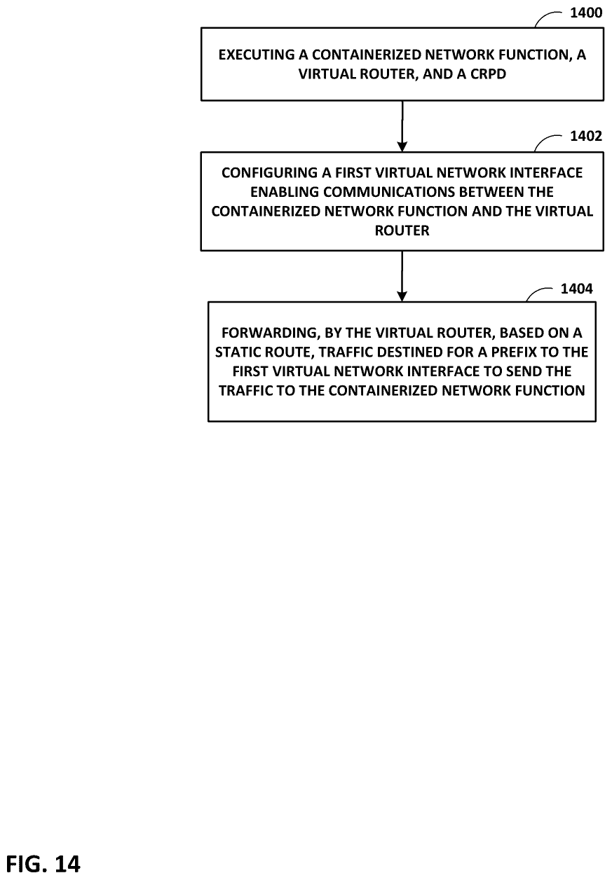

FIG. 14 is a flowchart illustrating an example mode of operation for a computing device, according to techniques described in this disclosure. The mode of operation is described with respect to computing device 200 of FIG. 2. Computing device 200 executes a containerized network function 22A (implemented in FIG. 2 by one or more container(s) 229A), a virtual router 206 to implement a data plane for a containerized router, and a containerized routing protocol daemon 324 to implement a control plane for the containerized router (1400). Containerized network function 22A and containerized routing protocol daemon 324 execute on the same computing device 200. Computing device 200 configures a first virtual network interface 212A enabling communications between containerized network function 22A and virtual router 206 (1402). Virtual router 206 forwards, based on a static route, traffic destined for a prefix to first virtual network interface 212A to send the traffic to containerized network function 22A (1404).

The techniques described herein may be implemented in hardware, software, firmware, or any combination thereof. Various components, functional units, and/or modules illustrated in the figures and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device. Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated. Further, each module, data store, component, program, executable, data item, functional unit, or other item illustrated within a storage device may be implemented in various ways. For example, each module, data store, component, program, executable, data item, functional unit, or other item illustrated within a storage device may be implemented as part of an operating system executed on a computing device.

If implemented in hardware, this disclosure may be directed to an apparatus such as a processor or an integrated circuit device, such as an integrated circuit chip or chipset. Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random access memory (RAM), read-only memory (ROM), non-volatile random access memory (NVRAM), electrically erasable programmable read-only memory (EEPROM), Flash memory, magnetic or optical data storage media, and the like. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

What is claimed is:

1. A computing device comprising:
processing circuitry having access to memory, the processing circuitry and memory configured to execute:
a containerized network function;
a virtual router to implement a data plane for a containerized router; and
a containerized routing protocol daemon to implement a control plane for the containerized router, wherein the containerized network function and containerized routing protocol daemon execute on the same computing device;
a first virtual network interface enabling communications between the containerized network function and the virtual router,
wherein the virtual router is configured with a static route to cause the virtual router to forward traffic destined for a prefix to the first virtual network interface to send the traffic to the containerized network function.

2. The computing device of claim 1, further comprising:
a second virtual network interface enabling communications between the containerized network function and the virtual router, the second virtual network interface different from the first virtual network interface,
wherein the containerized network function is configured to send traffic processed by the containerized network function to the virtual router via the second virtual network interface.

3. The computing device of claim 1,
wherein the containerized routing protocol daemon is configured to advertise the prefix to attract traffic destined for the prefix to the computing device.

4. The computing device of claim 3,
wherein the containerized routing protocol daemon is configured to execute one or more routing protocols to exchange routing information with routers external to the computing device, and
wherein the containerized routing protocol daemon is configured to advertise the prefix using the one or more routing protocols.

5. The computing device of claim 1, wherein the traffic destined for the prefix comprises first traffic destined for the prefix, further comprising:
a physical interface;
a second virtual network interface enabling communications between the containerized network function and the virtual router, the second virtual network interface different from the first virtual network interface,
wherein the virtual router is configured to apply the static route based on the first traffic destined for the prefix being received on the physical interface, and
wherein the virtual router is configured to, based on second traffic destined for the prefix being received on the second virtual network interface from the containerized network function, apply a different route to forward the second traffic to a downstream router.

6. The computing device of claim 1, wherein the containerized network function is configured to implement a secure tunnel for the traffic destined for the prefix.

7. The computing device of claim 1, wherein the containerized network function is configured to implement one of a broadband network gateway (BNG), Intrusion Detection and Prevention (IDP/IDS), Traffic Monitor, Network Address Translation device, or IPSec.

8. The computing device of claim 1, wherein the processing circuitry and memory are configured to execute:
a container network interface plugin configured to configure the first virtual network interface based on a network attachment definition obtained by an orchestrator for the containerized router.

9. The computing device of claim 8, further comprising:
a second virtual network interface enabling communications between the containerized network function and the virtual router, the second virtual network interface different from the first virtual network interface,
wherein the containerized network function is configured to send traffic processed by the containerized network function to the virtual router via the second virtual network interface,
wherein the network attachment definition comprises a first network attachment definition, and
wherein the container network interface plugin is configured to configure the second virtual network interface based on a second network attachment definition obtained by the orchestrator.

10. The computing device of claim 8,
wherein the container network interface plugin is configured to configure, based on container specification data obtained by the orchestrator, the containerized router with a route for the prefix, and
wherein the containerized router is configured to advertise the route.

11. The computing device of claim 10,
wherein the container specification data indicates the route for the prefix with an advertise routes field.

12. A computing system comprising:
an orchestrator; and
a computing device configured with:
a containerized network function;
a virtual router to implement a data plane for a containerized router; and
a containerized routing protocol daemon to implement a control plane for the containerized router, wherein the containerized network function and containerized routing protocol daemon execute on the same computing device;
a first virtual network interface enabling communications between the containerized network function and the virtual router;
a container network interface plugin,
wherein the orchestrator is configured to:
obtain a network attachment definition; and
cause the container network interface plugin to configure the first virtual network interface based on the network attachment definition,
wherein the virtual router is configured with a static route to cause the virtual router to forward traffic destined for a prefix to the first virtual network interface to send the traffic to the containerized network function.

13. The computing system of claim 12,
wherein the computing device is configured with:
a second virtual network interface enabling communications between the containerized network function and the virtual router, the second virtual network interface different from the first virtual network interface,
wherein the containerized network function is configured to send traffic processed by the containerized network function to the virtual router via the second virtual network interface,
wherein the network attachment definition comprises a first network attachment definition, and
wherein the orchestrator is configured to:
obtain a second network attachment definition; and
cause the container network interface plugin to configure the second virtual network interface based on the second network attachment definition.

14. The computing system of claim 12,
wherein the orchestrator is configured to:
obtain container specification data for the containerized network function; and
cause the container network interface plugin to configure the containerized router with a route for the prefix,
wherein the containerized router is configured to advertise the route.

15. The computing system of claim 14, wherein the container specification data indicates the route for the prefix with an advertise routes field.

16. A method comprising:
executing, with a computing device:
a containerized network function;
a virtual router to implement a data plane for a containerized router; and
a containerized routing protocol daemon to implement a control plane for the containerized router,
wherein the containerized network function and containerized routing protocol daemon execute on the same computing device, and
wherein a first virtual network interface of the computing device enables communications between the containerized network function and the virtual router; and
forwarding, by the virtual router, based on a static route, traffic destined for a prefix to the first virtual network interface to send the traffic to the containerized network function.

17. The method of claim 16,
wherein a second virtual network interface enables communications between the containerized network function and the virtual router, the second virtual network interface different from the first virtual network interface,
the method further comprising:
sending, by the containerized network function, traffic processed by the containerized network function to the virtual router via the second virtual network interface.

18. The method of claim 16, further comprising:
advertising, by the containerized routing protocol daemon, the prefix to attract traffic destined for the prefix to the computing device.

19. The method of claim 16, wherein the containerized network function is configured to implement a secure tunnel for the traffic destined for the prefix.

20. The method of claim 16, further comprising:
executing, with the computing device, a container network interface plugin;
configuring, by the container network interface plugin, the first virtual network interface based on a network attachment definition obtained by an orchestrator for the containerized router.
